(19) United States
(12) Patent Application Publication
(10) Pub. No.: US 2026/0052433 A1
(43) Pub. Date: Feb. 19, 2026

(54) Self-Organizing Network Reporting

(71) Applicant: Telefonaktiebolaget LM Ericsson (publ), Stockholm (SE)

(72) Inventors: Gautham Nayak Seetanadi, Stockholm (SE); Tahmineh Torabian Esfahani, Sollentuna (SE); Ali Parichehrehteroujeni, Linköping (SE); Angelo Centonza, Granada Granada (ES); Marco Belleschi, Solna (SE)

(21) Appl. No.: 19/101,093

(22) PCT Filed: Aug. 8, 2023
(86) PCT No.: PCT/SE2023/050789

§ 371 Date: Feb. 4, 2025

Related U.S. Application Data
(60) Provisional application No. 63/396,206, filed on Aug. 8, 2022.

(51) Int. Cl. H04W 36/00; H04W 36/30; H04W 74/0833

(52) U.S. Cl. CPC H04W 36/0061; H04W 36/0022; H04W 36/0079; H04W 36/305; H04W 74/0833

(57) ABSTRACT

A method performed by a communication device (12) is disclosed. The communication device (12) stores, at the communication device (12), a self-organizing network, SON, report (16) associated with a non-public network, NPN, including storing the SON report (16) in association with an NPN identifier of the NPN with which the SON report (16) is associated. The communication device (12) also transmits a message to the serving network indicating that the SON report (16) is available at the communication device (12), if a serving network of the communication device (12) is an NPN identified by an NPN identifier which matches the NPN identifier associated with the SON report (16).

### TECHNICAL FIELD

The present application relates generally to a communication network and relates more particularly to self-organizing network (SON) reporting in such a network.

### BACKGROUND

Self-organizing network (SON) functionality refers to the automation of communication network planning, configuration, and/or optimization. SON functionality may for example enable a communication network to perform self-configuration, self-optimization, and/or self-healing to some extent. Self-configuration in this regard refers to the configuration of newly deployed network nodes, e.g., for dynamic plug-and-play configuration, as well as to the ongoing configuration optimization of already deployed network nodes, e.g., automatic neighbor relation (ANR) functionality. Self-optimization refers to the optimization of coverage, capacity, handover, and/or interference in a communication network, e.g., mobility robustness optimization (MRO) to automatically detect and correct errors in mobility configuration such as errors that cause radio link failure (RLF) due to too late or early handover. Self-healing allows the communication network to heal itself when network nodes fail and/or connectivity is lost, e.g., through adjustment of cell parameters governing cell capacity and/or coverage.

Communication devices served by a communication network support SON functionality by collecting SON reports and providing those SON reports to the communication network. SON reports include, for example, RLF reports, random access (RA) reports, connection establishment failure reports, successful PSCell report (SPR), secondary cell group (SCG) failure reports, successful handover reports, and/or any type of report that is generated and stored in response to defined events for the support of SON functionality.

Some contexts introduce challenges to SON reporting by threatening the loss of SON reports. For example, a communication device heretofore stores the latest RLF report until the RLF report is fetched by the communication network or for 48 hours after the connection failure reported by the RLF report is detected. Problematically, another connection failure might occur before the RLF report is fetched. This may happen, for example, if the communication device stores an RLF report for a connection failure experienced in a public network, performs mobility from the public network to a non-public network (NPN), and experiences another connection failure in the non-public network before the RLF report for the public network is fetched. In this case, the communication device heretofore overwrites the RLF report stored for the public network, in favor of storing an RLF report for the latest connection failure in the non-public network. This leads to the RLF report for the public network being lost, preventing the public network's operator from performing SON using the RLF report.

In these and other cases, SON report loss threatens communication networks with sub-optimal performance, e.g., in terms of increased RLF occurrences that could have been avoided without RLF report loss.

### SUMMARY

Some embodiments herein advantageously mitigate self-organizing network (SON) report loss in a communication device. According to one implementation, for example, a communication device stores SON reports that are of different types, and/or that are associated with different types of communication networks, in different data structures at the communication device, e.g., different variables or lists. In another implementation, by contrast, the communication device stores SON reports in the same data structure, but stores indications of which communication networks or communication network types the stored SON reports relate, so that the communication device can exploit those indications for managing storage of SON reports, e.g., the communication device can delete SON report(s) on a communication network type by communication network type basis. Regardless of the particular implementation, some embodiments herein advantageously enable the communication device to simultaneously store multiple SON reports, e.g., of the same type and/or for different types of communication networks.

Storing SON reports in these and other ways described herein advantageously preserves storage of one or more SON reports that would have heretofore been deleted or overwritten. By mitigating SON report loss, some embodiments herein improve SON reporting to a communication network, which in turn improves communication network performance.

More particularly, embodiments herein include a method performed by a communication device. The method comprises storing, at the communication device, a self-organizing network, SON, report associated with a non-public network, NPN, including storing the SON report in association with an NPN identifier of the NPN with which the SON report is associated. The method also comprises, if a serving network of the communication device is an NPN identified by an NPN identifier which matches the NPN identifier associated with the SON report, transmitting a message to the serving network indicating that the SON report is available at the communication device.

In some embodiments, the method further comprises checking if the serving network of the communication device is an NPN identified by an NPN identifier which matches the NPN identifier associated with the SON report. In some embodiments, transmitting the message comprises transmitting the message if, according to said checking, the serving network of the communication device is an NPN identified by an NPN identifier which matches the NPN identifier associated with the SON report.

In some embodiments, the NPN is a standalone NPN, and the NPN identifier is a combination of a Public Land Mobile Network (PLMN) identifier and a Network ID (NID).

In some embodiments, the SON report includes radio link failure information or handover failure information in the NPN.

In some embodiments, storing the NPN report in association with an NPN identifier of the NPN with which the SON report is associated comprises storing the NPN identifier in the NPN report.

In some embodiments, the method further comprises, after transmitting the message, receiving a request from the serving network node for the SON report. In some embodiments, the method further comprises, responsive to the request, transmitting the SON report to the serving network.

Other embodiments herein include a method performed by a communication device. The method comprises simultaneously storing multiple self-organizing network, SON, reports at the communication device, including an SON report associated with a non-public network. In some embodiments, the method comprises simultaneously storing multiple self-organizing network, SON, reports by storing the multiple SON reports in a data structure that is common to multiple communication networks or multiple types of communication networks, with each SON report being stored with a respective network identifier identifying a communication network associated with the SON report and/or a respective network type identifier identifying a type of a communication network associated with the SON report. In other embodiments, the method comprises simultaneously storing multiple self-organizing network, SON, reports by storing the multiple SON reports across different data structures that are specific to different respective communication networks and/or specific to different respective types of communication networks.

In some embodiments, simultaneously storing multiple SON reports comprises, while in a first communication network, generating and storing one or more first SON reports at the communication device. In some embodiments, simultaneously storing multiple SON reports comprises performing mobility from the first communication network to a second communication network. In some embodiments, simultaneously storing multiple SON reports comprises, while in the second communication network, generating and storing one or more second SON reports at the communication device, without deleting or overwriting the one or more first SON reports stored at the communication device such that the one or more second SON reports are simultaneously stored at the communication device with the one or more first SON reports. In some embodiments, one of the first and second communication networks is a public network and the other of the first and second communication networks is a non-public network. In some embodiments, the method further comprises, after performing mobility to the second communication network, transmitting the one or more first SON reports and/or the one or more second SON reports.

In some embodiments, the method further comprises deleting SON reports associated with different types of communication networks responsive to different deletion events. In some embodiments, the different deletion events are respectively associated with the different types of communication networks, wherein the different types of communication networks include a public network and a non-public network.

In some embodiments, said storing comprises storing the multiple SON reports across the different data structures, wherein the different data structures are specific to different respective types of communication networks. In some embodiments, the different respective types of communication networks include a public network and a non-public network.

In some embodiments, said storing comprises storing the multiple SON reports across the different data structures. In some embodiments, the data structures are variables or lists.

In some embodiments, simultaneously storing multiple SON reports at the communication device comprises simultaneously storing multiple SON reports of the same type. In some embodiments, each of the SON reports includes radio link failure information or handover failure information.

In some embodiments, simultaneously storing multiple SON reports at the communication device comprises simultaneously storing, at the communication device, the latest N SON reports, where N>1. In some embodiments, each SON report is stored until the SON report is fetched by a communication network or until a storage expiration time expires, whichever occurs first.

Other embodiments herein include a method performed by a network node. The method comprises receiving, from a communication device, a message containing a non-public network, NPN, self-optimizing network, SON, report that is specific to NPNs. The method also comprises, based on the NPN SON report, adapting a configuration of a communication network to which the NPN SON report relates.

In some embodiments, the NPN SON report includes an identifier of an NPN to which the NPN SON report relates.

In some embodiments, the NPN SON report is an NPN radio link failure, RLF, report or an NPN random access channel, RACH, report.

In some embodiments, the network node belongs to a different communication network than a communication network to which the NPN SON report relates, and the method further comprises forwarding the NPN SON report to the communication network to which the NPN SON report relates.

Other embodiments herein include a communication device. The communication device is configured to store, at the communication device, a self-organizing network, SON, report associated with a non-public network, NPN, including storing the SON report in association with an NPN identifier of the NPN with which the SON report is associated. The communication device is also configured to, if a serving network of the communication device is an NPN identified by an NPN identifier which matches the NPN identifier associated with the SON report, transmit a message to the serving network indicating that the SON report is available at the communication device.

In some embodiments, the communication device is configured to perform the steps described above for a communication device.

Other embodiments herein include a communication device. The communication device is configured to simultaneously store multiple self-organizing network, SON, reports at the communication device, including an SON report associated with a non-public network. In some embodiments, the communication device is configured to simultaneously store multiple self-organizing network, SON, reports by storing the multiple SON reports in a data structure that is common to multiple communication networks or multiple types of communication networks, with each SON report being stored with a respective network identifier identifying a communication network associated with the SON report and/or a respective network type identifier identifying a type of a communication network associated with the SON report. In other embodiments, the communication device is configured to simultaneously store multiple self-organizing network, SON, reports by storing the multiple SON reports across different data structures that are specific to different respective communication networks and/or specific to different respective types of communication networks.

In some embodiments, the communication device is configured to perform the steps described above for a communication device.

Other embodiments herein include a network node. The network node is configured to receive, from a communication device, a message containing a non-public network, NPN, self-optimizing network, SON, report that is specific to NPNs. The network node is also configured to, based on the NPN SON report, adapt a configuration of a communication network to which the NPN SON report relates.

In some embodiments, the network node is configured to perform the steps described above for a network node.

In some embodiments, a computer program comprising instructions which, when executed by at least one processor of a communication device, causes the communication device to perform the steps described above for a communication device. In some embodiments, a computer program comprising instructions which, when executed by at least one processor of a network node, causes the network node to perform the steps described above for a network node. In some embodiments, a carrier containing the computer program is one of an electronic signal, optical signal, radio signal, or computer readable storage medium.

Other embodiments herein include a communication device. The communication device comprises communication circuitry and processing circuitry. The processing circuitry is configured to store, at the communication device, a self-organizing network, SON, report associated with a non-public network, NPN, including storing the SON report in association with an NPN identifier of the NPN with which the SON report is associated. The processing circuitry is also configured to, if a serving network of the communication device is an NPN identified by an NPN identifier which matches the NPN identifier associated with the SON report, transmit a message to the serving network indicating that the SON report is available at the communication device.

In some embodiments, the processing circuitry is configured to perform the steps described above for a communication device.

Other embodiments herein include a communication device. The communication device comprises communication circuitry and processing circuitry. The processing circuitry is configured to simultaneously store multiple self-organizing network, SON, reports at the communication device, including an SON report associated with a non-public network. In some embodiments, the processing circuitry is configured to simultaneously store multiple self-organizing network, SON, reports by storing the multiple SON reports in a data structure that is common to multiple communication networks or multiple types of communication networks, with each SON report being stored with a respective network identifier identifying a communication network associated with the SON report and/or a respective network type identifier identifying a type of a communication network associated with the SON report. In other embodiments, the processing circuitry is configured to simultaneously store multiple self-organizing network, SON, reports by storing the multiple SON reports across different data structures that are specific to different respective communication networks and/or specific to different respective types of communication networks.

In some embodiments, the processing circuitry is configured to perform the steps described above for a communication device.

Other embodiments herein include a network node. The network node comprises communication circuitry and processing circuitry. The processing circuitry is configured to receive, from a communication device, a message containing a non-public network, NPN, self-optimizing network, SON, report that is specific to NPNs. The processing circuitry is also configured to, based on the NPN SON report, adapt a configuration of a communication network to which the NPN SON report relates.

In some embodiments, the processing circuitry is configured to perform the steps described above for a network node.

### BRIEF DESCRIPTION OF THE DRAWINGS

FIG. 1 is a block diagram of a communication system in accordance with some embodiments.

FIG. 2 is a block diagram of a communication device storing self-organizing network, SON, reports.

FIG. 3 is a block diagram of a communication device storing self-organizing network, SON, reports in a common data structure.

FIG. 4 is a block diagram of a communication device storing self-organizing network, SON, reports to mitigate SON report loss.

FIG. 5 is a logic flow diagram of a method performed by a communication device in accordance with particular embodiments.

FIG. 6 is a logic flow diagram of a method performed by a communication device in accordance with other particular embodiments.

FIG. 7 is a logic flow diagram of a method performed by a communication device in accordance with particular embodiments.

FIG. 8 is a logic flow diagram of a method performed by a communication device in accordance with other particular embodiments.

FIG. 9 is a logic flow diagram of a method performed by a communication device in accordance with other particular embodiments.

FIG. 10 is a logic flow diagram of a method performed by a network node in accordance with other particular embodiments.

FIG. 11 is a logic flow diagram of a method performed by a network node in accordance with other particular embodiments.

FIG. 12 is a block diagram of a communication device as implemented in accordance with one or more embodiments.

FIG. 13 is a block diagram of a network node as implemented in accordance with one or more embodiments.

FIG. 14 is a block diagram of a communication system in accordance with some embodiments.

FIG. 15 is a block diagram of a user equipment according to some embodiments.

FIG. 16 is a block diagram of a network node according to some embodiments.

FIG. 17 is a block diagram of a host according to some embodiments.

FIG. 18 is a block diagram of a virtualization environment according to some embodiments.

FIG. 19 is a block diagram of a host communicating via a network node with a UE over a partially wireless connection in accordance with some embodiments.

### DETAILED DESCRIPTION

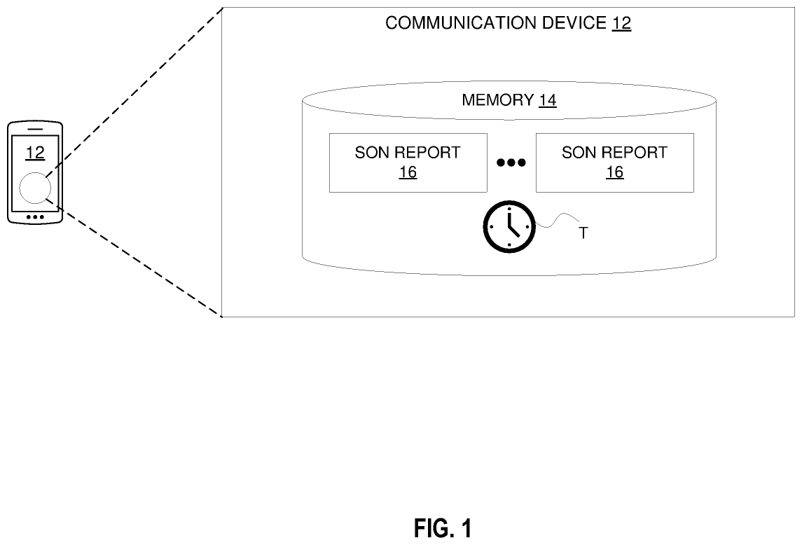

FIG. 1 shows a communication device 12 according to some embodiments, e.g., a wireless communication device. The communication device 12 as shown is configured to store (i.e., log) self-organizing network (SON) reports 16, e.g., in memory 14 at the communication device 12.

SON reports 16 as used herein refer to reports usable for SON. SON refers to the automation of communication network planning, configuration, and/or optimization. SON reports include, for example, radio link failure (RLF) reports, random access (RA) reports, connection establishment failure reports, successful PSCell report (SPR), secondary cell group (SCG) failure reports, successful handover reports, and/or any type of report that is generated and stored in response to defined events for the support of SON functionality. Regardless, by storing and providing SON reports 16 in this regard, the communication device 12 supports SON.

FIG. 1 notably shows that the communication device 12 is capable of simultaneously storing multiple SON reports 16 at the communication device 12. In fact, in some embodiments, the communication device 12 is capable of simultaneously storing multiple SON reports 16 of the same type, e.g., multiple RLF reports, multiple connection establishment failure reports, multiple secondary cell group failure reports, or multiple successful handover reports. In these and other embodiments, then, the stored SON reports 16 may report respective occurrences of an SON event, e.g., an RLF event.

In some embodiments, for example, rather than only storing the latest SON report of a certain type, the communication device 12 stores the latest N SON reports of that certain type, where N>1, e.g., the latest N RLF reports. In one such embodiment, the communication device 12 stores the latest N SON reports 16 of a certain type, where each SON report 16 is stored until the SON report 16 is fetched by a communication network or until a storage expiration time expires, whichever occurs first.

In these and other embodiments, then, the simultaneously stored SON reports 16 may include multiple SON reports of the same type.

Alternatively or additionally, the simultaneously stored SON reports 16 may include SON reports that are associated with different types of communication networks. The different types of communication networks may for example include public networks and non-public networks (NPNs). Here, a non-public network (NPN) is a network that is intended for non-public use. An NPN may for instance be intended for the sole use of a private entity such as an enterprise. Regardless, an NPN may be a standalone NPN (SNPN) that is capable of operating without dependency on a Public Land Mobile Network (PLMN). In this case, the SNPN may be identified by a combination of a PLMN ID and a Network ID (NID). Or, an NPN may be a Public Network integrated NPN (PNiNPN) that is deployed with the support of a PLMN. In this case, for example, a PLMN may dedicate a network slice to the PNiNPN and employ the use of a Closed Access Group (CAG) for access control.

Regardless, by enabling the communication device 12 to simultaneously store multiple SON reports 16, e.g., of the same type and/or for different types of communication networks, some embodiments advantageously preserve storage of one or more SON reports 16 that would have heretofore been deleted or overwritten. By mitigating SON report loss, some embodiments herein improve SON reporting to a communication network, which in turn improves communication network performance.

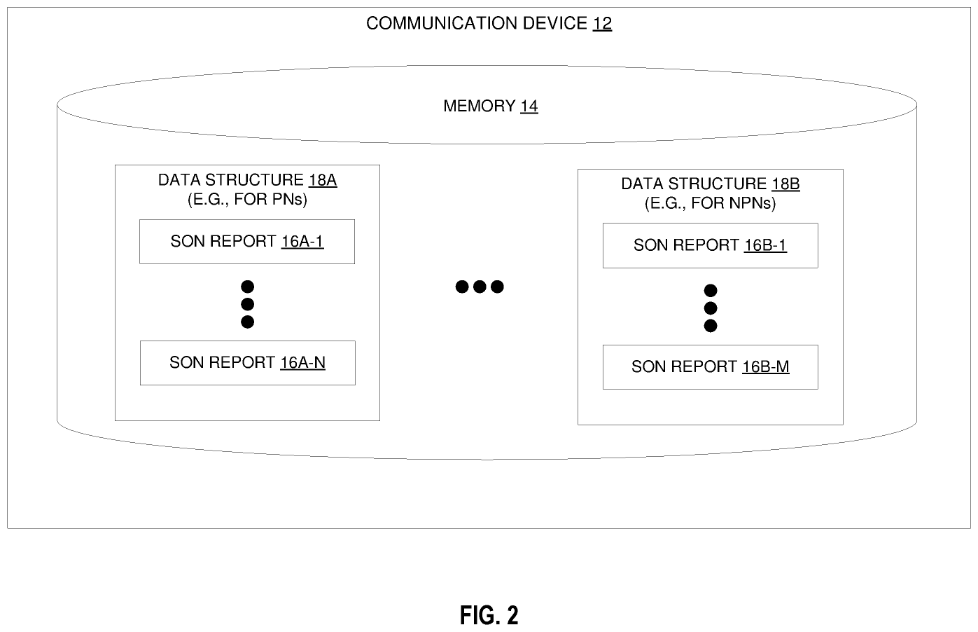

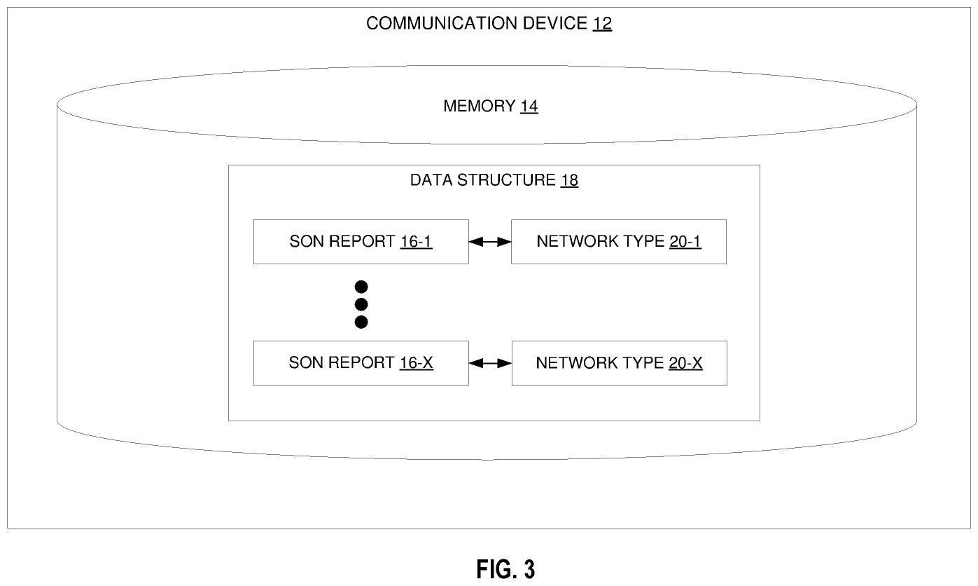

FIGS. 2 and 3 illustrate other embodiments herein for storing SON reports 16 at the communication device 12, e.g., in a way that supports simultaneous storage of multiple SON reports 16. As shown in FIG. 2, the communication device 12 stores, in different data structures 18A, 18B, SON reports that are of different types and/or that are associated with different types of communication networks. For instance, as shown, the communication device 12 stores SON reports 16A-1 . . . 16A-N in data structure 18A, but stores SON reports 16B-1 . . . 16B-M in data structure 18B. The communication device 12 does so on the basis that SON reports 16A-1 . . . 16A-N are of a different type and/or are associated with a different type of communication network than SON reports 16B-1 . . . 16B-M.

Here, the different data structures 18A, 18B may be different variables, different lists, or any other type of structure capable of storing SON reports. Regardless, in some embodiments, the different data structures 18A, 18B are effectively earmarked or dedicated for storage of SON reports that are of different types and/or that are associated with different types of communication networks. In these and other embodiments, then, the data structures 18A, 18B may effectively be report type specific and/or network type specific. The data structures 18A, 18B may for instance each be associated with a respective network type identifier identifying a type of a communication network associated with the data structure.

In the case that the data structures 18A, 18B are network type specific and report type specific, the data structures 18A, 18B may store the same type of SON reports for different types of communication networks. For example, the data structures 18A, 18B may store RLF reports associated with different types of communication networks.

FIG. 2 shows one example where the different types of communication networks include public networks and non-public networks. As shown, for instance, the communication device 12 stores SON reports 16A-1 . . . 16A-N associated with public networks (PNs) in data structure 18A but stores SON reports 16B-1 . . . 16B-M associated with NPNs in data structure 18B.

FIG. 3 shows other embodiments herein in which the communication device 12 stores, in a common data structure 18, SON reports 16-1 . . . 16-X that may be associated with different types of communication networks. As shown in this case, though, the communication device 12 stores each SON report along with a respective network type identifier identifying a type of a communication network associated with the SON report. FIG. 3 shows for instance that the communication device 12 stores SON report 16-1 along with an indication 20-1 of a network type associated with SON report 16-1, stores SON report 16-X along with an indication 20-X of a network type associated with SON report 16-X, etc.

No matter the particular way that the communication device 12 stores multiple SON reports, though, e.g., as described in FIG. 2 or 3, some embodiments herein enable the communication device 12 to advantageously preserve storage of one or more SON reports that would have heretofore been deleted or overwritten. By mitigating SON report loss, some embodiments herein improve SON reporting to a communication network, which in turn improves communication network performance.

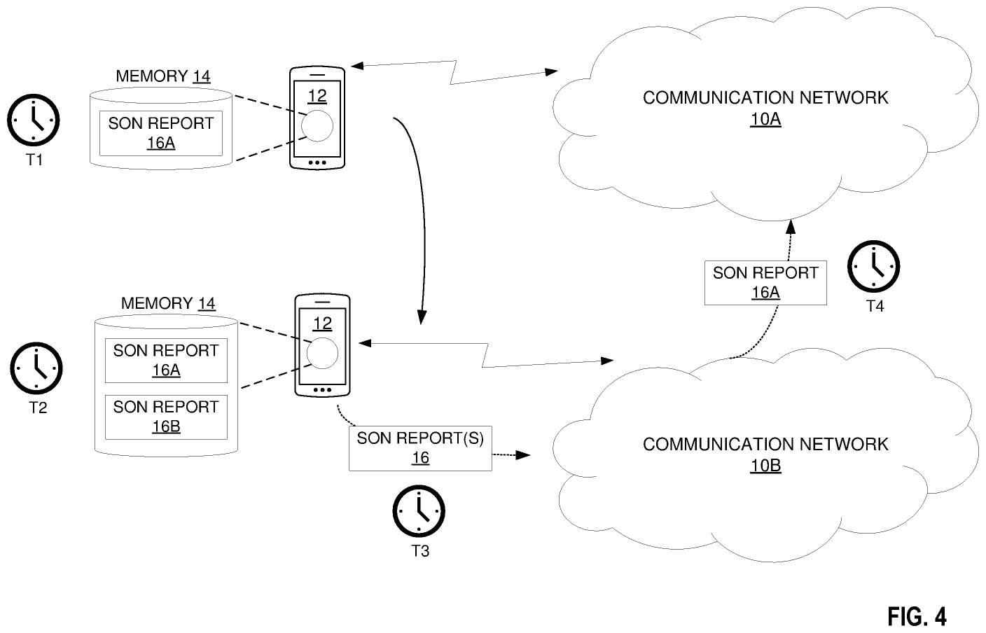

FIG. 4 shows one example. While in communication network 10A, e.g., a public network, the communication device 12 generates and stores an SON report 16A in memory 14 (at time T1). The communication device 12 thereafter performs mobility from communication network 10A to communication network 10B, e.g., where communication network 10B is a non-public network (NPN). The communication device 12 may do so before communication network 10A can retrieve the SON report 16A. Then, while in communication network 10B, the communication device 12 generates and stores another SON report 16B in memory 14 (at time T2). Notably, the communication device 12 does so in accordance with FIGS. 1, 2, and/or 3, in order to store SON report 16B without deleting or overwriting SON report 16A, i.e., at time T2 the communication device 12 simultaneously stores SON reports 16A and 16B. As demonstrated by this example, then, the communication device 12 may thereby selectively keep or delete SON report(s) on a network type by network type basis.

In some embodiments, for example, communication network 10A is a public network whereas communication network 10B is an NPN, such that the communication device 12 stores the SON reports 16A, 16B in different data structures specific for different types of networks. In this case, the communication device 12 adds SON report 16B to the data structure specific to NPNs, without having to delete or overwrite SON report 16A stored in the data structure specific to PNs.

Regardless, having preserved SON report 16A despite mobility to communication network 10B, the communication device 12 later transmits SON report(s) 16 (including SON report 16A) to communication network 10B (at time T3). The communication device 12 may do so for example upon notifying communication network 10B of the availability of the SON report(s) 16 and upon the communication network 10B requesting the available SON report(s) 16. Then, communication network 10B may forward SON report 16A to communication network 10A, so that communication network 10A can perform SON based on the SON report 16A.

Consider now some embodiments herein where a communication network 10 may be characterized as a public network or a non-public network (NPN), and where a communication device 12 may be exemplified as a user equipment (UE).

### NPN

NPN, which stands for Non-Public Network, is a feature which allows for a network to be deployed and/or managed by an entity other than a normal operator. A “normal operator” here is assumed to be an operator of one or more PLMNs, i.e., Public Land Mobile Networks. It should be noted that a PLMN also has an identify which is called the PLMN ID, or sometimes just referred to as the “PLMN”.

There are two types of NPN networks, namely SNPNs and PNI-NPNs which are described below.

A first network or network identifier, e.g., a PLMN, can be configured as equivalent to another network or network identifier. For example, the operator of one network can make an agreement with another operator such that the users of these networks can view the networks equivalent. An equivalent PLMN (EPLMN) in this regard is a PLMN that is configured as equivalent to another PLMN. There is in current 3GPP specifications no equivalent SNPN networks, but it would be possible to introduce the concept of equivalent SNPNs in the future. (In case of PNI-NPNs the concept of EPLMN is implicitly applied.)

NPN is only specified for New Radio (NR) access.

### SNPN

SNPN, which stands for Stand-alone NPN, is a flavor or an NPN which is not relying on network functions provided by a PLMN (quote from TS 23.501 V17.5.0). For example, it may be a private company who deploys a network, but that company is not/does not own a PLMN. It could for example be a company who owns factories and deploys networks in and around the factories for the sake of providing service to its employees and machines, etc.

An SNPN network has an identifier which comprises a PLMN-identity and a NID (Network IDentity). One way for the SNPN network owner to acquire an SNPN identifier is to make an agreement with a PLMN operator so that such SNPN's identity comprises that operator's PLMN ID. Another approach is that a “dummy” (i.e., “special” or “not normally used” or “invalid” or similar) PLMN ID is used as part of the identity of the SNPN.

### PNI-NPN

The PNI-NPN feature is another flavor of an NPN. PNI-NPN stands for Public Network Integrated-Non-Public Network. Similar to SNPN, a PNI-NPN may be deployed to offer service to a certain set of users, for example to employees and machines, etc., of a company. The main difference between SNPN and PNI-NPN is that a PNI-NPN is integrated into a PLMN. A PNI-NPN may therefore be managed by the operator of the PLMN into which the PNI-NPN is integrated.

The PNI-NPN has, instead of the NID-identifier which SNPNs use, an identifier called CAG which stands for Closed Access Group. A CAG is associated to each cell forming the PNI-NPN. The UEs of the employees, machines, etc., of the company who should be given access to the PNI-NPN are configured with the relevant CAG. Other UEs do not have access to the PNI-NPN and are not configured to use the CAG. In the general case, both the UE and the network perform a check when determining if the UE can connect to a PNI-NPN by looking at if the UE is configured with the CAG and only if that is the case, the UE is given access to the PNI-NPN.

### RLF Report

Some embodiments herein are applicable where SON reports are RLF reports as otherwise described below. Radio link failure (RLF) in this regard occurs when there is a failure in transmissions between the UE and the base station. When the UE is in RRC_Connected state, it performs radio link monitoring based on the reference signals and signal quality thresholds, where these values are configured by the network. Various criterion when a UE declares RLF is described in section 9.2.7 RADIO LINK FAILURE of TS 38.300 V17.1.0.

The UE prepares a report in case of RLF aptly named RLF report, and makes the RLF report available to the network. The UE heretofore stores reports related to both Long Term Evolution (LTE) and New Radio (NR) until the report is fetched, or the UE stores it up to 48 hours after the RLF is detected. In particular, the UE heretofore stores the latest RLF Report, including both LTE and NR RLF report, until the RLF report is fetched by the network or for 48 hours after the connection failure is detected.

The UE heretofore only indicates RLF report availability and only provides the RLF report to the network if the current Registered PLMN (RPLMN) is a PLMN that was present in the UE's EPLMN List or was the RPLMN at the time the connection failure was detected. In case RLF happens in an Evolved Universal Mobile Telecommunications System (UMTS) Terrestrial Radio Access (E-UTRA) cell, the UE heretofore makes the LTE RLF Report available to Next Generation (NG) Radio Access Network (NG-RAN) nodes and eNB(s), and in case RLF happens in an NR cell the UE heretofore makes the NR RLF Report available to gNB(s).

If the LTE RLF Report is reported to a NG-RAN node, and the last serving node is an E-UTRAN node, the NG-RAN node may transfer it to the E-UTRAN node by triggering the Uplink RAN configuration transfer procedure over NG and the E-UTRAN node can take this into account as defined in TS 36.300 v17.0.0.

The UE heretofore can notify the network about the presence of RLF report and sends it via the variable RLF-report-r16 variable as described in TS 38.331 V17.0.0:

Begin Extract from 38.331 V17.0.0

| RLF-Report-r16 ::= | CHOICE { | |
|---|---|---|
| nr-RLF-Report-r16 | SEQUENCE { | |
| measResultLastServCell-r16 | MeasResultRLFNR-r16, | |
| measResultNeighCells-r16 | SEQUENCE { | |
| measResultListNR-r16 | MeasResultList2NR-r16 | OPTIONAL, |
| measResultListEUTRA-r16 | MeasResultList2EUTRA-r16 | OPTIONAL |

} OPTIONAL,

| | |
|---|---|
| c-RNTI-r16 | RNTI-Value, |
| previousPCellId-r16 | CHOICE { |
| nrPreviousCell-r16 | CGI-Info-Logging-r16, |
| eutraPreviousCell-r16 | CGI-InfoEUTRALogging |

} OPTIONAL,

| | |
|---|---|
| failedPCellId-r16 | CHOICE { |
| nrFailedPCellId-r16 | CHOICE { |
| cellGlobalId-r16 | CGI-Info-Logging-r16, |
| pci-arfcn-r16 | SEQUENCE { |
| physCellId-r16 | PhysCellId, |
| carrierFreq-r16 | ARFCN-ValueNR |

```
        }
      },
```

| | |
|---|---|
| eutraFailedPCellId-r16 | CHOICE { |
| cellGlobalId-r16 | CGI-InfoEUTRALogging, |
| pci-arfcn-r16 | SEQUENCE { |
| physCellId-r16 | EUTRA-PhysCellId, |
| carrierFreq-r16 | ARFCN-ValueEUTRA |

```
        }
      }
    },
```

| | |
|---|---|
| reconnectCellId-r16 | CHOICE { |
| nrReconnectCellId-r16 | CGI-Info-Logging-r16, |
| eutraReconnectCellId-r16 | CGI-InfoEUTRALogging |

} OPTIONAL,

| timeUntilReconnection-r16 | TimeUntilReconnection-r16 | OPTIONAL, |
|---|---|---|
| reestablishmentCellId-r16 | CGI-Info-Logging-r16 | OPTIONAL, |
| timeConnFailure-r16 | INTEGER (0..1023) | OPTIONAL, |
| timeSinceFailure-r16 | TimeSinceFailure-r16, | |
| connectionFailureType-r16 | ENUMERATED {rlf, hof}, | |
| rlf-Cause-r16 | ENUMERATED {t310-Expiry, randomAccessProblem, rlc-MaxNumRetx, | |
| | beamFailureRecoveryFailure, lbtFailure-r16, | |
| | bh-rlfRecoveryFailure, t312-expiry-r17, spare1}, | |
| locationInfo-r16 | LocationInfo-r16 | OPTIONAL, |
| noSuitableCellFound-r16 | ENUMERATED {true} | OPTIONAL, |
| ra-InformationCommon-r16 | RA-InformationCommon-r16 | OPTIONAL, |

```
    ...,
    [[
```

| | | |
|---|---|---|
| csi-rsRLMConfigBitmap-v1650 | BIT STRING (SIZE (96)) | OPTIONAL |

```
    ]],
    [[
```

| | | |
|---|---|---|
| lastHO-Type-r17 | ENUMERATED {cho, daps, spare2, spare1} | OPTIONAL, |
| timeConnSourceDAPS-Failure-r17 | TimeConnSourceDAPS-Failure-r17 | OPTIONAL, |
| timeSinceCHO-Reconfig-r17 | TimeSinceCHO-Reconfig-r17 | OPTIONAL, |

| | |
|---|---|
| choCellId-r17 | CHOICE { |
| cellGlobalId-r17 | CGI-Info-Logging-r16, |
| pci-arfcn-r17 | SEQUENCE { |
| physCellId-r17 | PhysCellId, |
| carrierFreq-r17 | ARFCN-ValueNR |

```
      }
    } OPTIONAL,
```

| | | |
|---|---|---|
| choCandidateCellList-r17 | ChoCandidateCellList-r17 | OPTIONAL |

```
    ]]
  },
```

| | |
|---|---|
| eutra-RLF-Report-r16 | SEQUENCE { |
| failedPCellId-EUTRA | CGI-InfoEUTRALogging, |
| measResult-RLF-Report-EUTRA-r16 | OCTET STRING, |

```
    ...
  }
}
```

End Extract from 38.331

The RLF report, once retrieved by the NG-RAN node, is heretofore sent to another appropriate NG-RAN node through the FAILURE INDICATION message and HANDOVER REPORT message. These messages are described in TS 38.423 V17.0.0.

Begin Extract from 38.423 V17.0.0

### 8.4.7 Failure Indication

### 8.4.7.1 General

The purpose of the Failure Indication procedure is to transfer information regarding RRC re-establishment attempts, or received RLF Reports, between NG-RAN nodes. The signalling takes place from the NG-RAN node at which a re-establishment attempt is made, or an RLF Report is received, to an NG-RAN node to which the UE concerned may have previously been attached prior to the connection failure. This may aid the detection of radio link failure, handover failure cases.

The procedure uses non UE-associated signalling.

In Successful Operation of the Failure indication procedure, NG-RAN node₂ initiates the procedure by sending the FAILURE INDICATION message to NG-RAN node₁, following a re-establishment attempt or an RLF Report reception from a UE at NG-RAN node₂, when NG-RAN node₂ considers that the UE may have previously suffered a connection failure at a cell controlled by NG-RAN node₁.

If the UE RLF Report Container IE is included in the FAILURE INDICATION message, NG-RAN node₁ shall use it to derive failure case information.

### 8.4.8 Handover Report

### 8.4.8.1 General

The purpose of the Handover Report procedure is to transfer mobility related information between NG-RAN nodes. The procedure uses non UE-associated signalling.

If NG-RAN node₁ receives a UE RLF Report from an NG-RAN node via the FAILURE INDICATION message, as described in TS 38.300 v17.0.0, NG-RAN node₁ may also include it in the UE RLF Report Container IE included in the HANDOVER REPORT message.

### 9.1.3.16 Failure Indication

This message is sent by NG-RAN node₂ to indicate an RRC re-establishment attempt or a reception of an RLF Report from a UE that suffered a connection failure at NG-RAN node₁.

Direction: NG-RAN node₂® NG-RAN node₁.

| | | | IE type | | | Assigned |
|---|---|---|---|---|---|---|
| IE/Group | Presence | Range | reference | Semantics description | Criticality | Criticality |
| . . . | . . . | . . . | . . . | . . . | . . . | . . . |
| >>>RRC | | | | | | |
| Reestab | | | | | | |
| Reporting with | | | | | | |
| RLF Report | | | | | | |
| >>>>UE | M | | 9.2.2.59 | nr-RLF-Report-r16 IE | — | |
| RLF | | | | contained in the | | |
| Report | | | | UEInformationResponse | | |
| Container | | | | message (TS 38.331 | | |
| | | | | v17.0.0) or RLF-Report- | | |
| | | | | r9 IE contained in the | | |
| | | | | UEInformationResponse | | |
| | | | | message (TS 36.331 | | |
| | | | | v17.0.0) | | |
| >RRC Setup | | | | | | |
| >>CHOICE | M | | | | — | |
| RRC Setup | | | | | | |
| Initiated | | | | | | |
| Reporting | | | | | | |
| >>>RRC Setup | | | | | | |
| Reporting with | | | | | | |
| RLF Report | | | | | | |
| >>>>UE | M | | 9.2.2.59 | nr-RLF-Report-r16 IE | — | |
| RLF | | | | contained in the | | |
| Report | | | | UEInformationResponse | | |
| Container | | | | message (TS 38.331 | | |
| | | | | v17.0.0) or RLF-Report- | | |
| | | | | r9 IE contained in the | | |
| | | | | UEInformationResponse | | |
| | | | | message (TS 36.331 | | |
| | | | | 17.0.0) | | |

### 9.1.3.17 Handover Report

This message is sent by NG-RAN node₁ to NG-RAN node₂ to report a handover failure event, or other critical mobility problem.

Direction: NG-RAN node₁® NG-RAN node₂.

| IE/Group | | | IE type and | Semantics | | Assigned |
|---|---|---|---|---|---|---|
| Name | Presence | Range | reference | description | Criticality | Criticality |
| . . . | . . . | . . . | . . . | . . . | . . . | . . . |
| UE RLF | O | | 9.2.2.59 | The UE RLF | YES | ignore |
| Report | | | | Report | | |
| Container | | | | Container IE | | |
| | | | | received in | | |
| | | | | the FAILURE | | |
| | | | | INDICATION | | |
| | | | | message. | | |
| CHO | O | | 9.2.2.76 | | YES | ignore |
| Configuration | | | | | | |

### 9.2.2.59 UE RLF Report

This IE contains the RLF Report to be transferred.

| IE/Group | | | IE type and | |
|---|---|---|---|---|
| Name | Presence | Range | reference | Semantics description |
| CHOICE type | M | | | |
| >NR | | | | |
| >>NR UE RLF | M | | OCTET | nr-RLF-Report-r16 IE contained in the |
| Report | | | STRING | UEInformationResponse message defined |
| Container | | | | in TS 38.331 17.0.0. |
| >LTE | | | | |
| >>LTE UE RLF | M | | OCTET | RLF-Report-r9 IE contained in the |
| Report | | | STRING | UEInformationResponse message defined |
| Container | | | | in TS 36.331 17.0.0 |

End Extract from 38.423

As seen in 38.300 V17.1.0, the RLF is heretofore only sent to the NG-RAN node if the PLMNs are declared as equivalent in the configuration or the PLMN where the RLF occurred is the same as the current one in the MOBILITY RESTRICTION LIST.

Begin Extract from 38.413

### 9.3.1.85 Mobility Restriction List

This IE defines roaming or access restrictions for subsequent mobility action for which the NG-RAN provides information about the target of the mobility action towards the UE, e.g., handover, or for SCG selection during dual connectivity operation or for assigning proper RNAs. NG-RAN behaviour upon receiving this IE is specified in TS 23.501 v17.5.0.

| IE/Group | | | IE type and | |
|---|---|---|---|---|
| Name | Presence | Range | reference | Semantics description |
| Serving PLMN | M | | PLMN | |
| | | | Identity | |
| | | | 9.3.3.5 | |
| Equivalent | | 0 . . . <maxnoofEPLMNs> | | Allowed PLMNs in |
| PLMNs | | | | addition to Serving |
| | | | | PLMN. |
| | | | | This list corresponds to |
| | | | | the list of “equivalent |
| | | | | PLMNs” as defined in TS |
| | | | | 24.501 v17.7.1. |
| | | | | This list is part of the |
| | | | | roaming restriction |
| | | | | information. Roaming |
| | | | | restrictions apply to |
| | | | | PLMNs other than the |
| | | | | Serving PLMN and |
| | | | | Equivalent PLMNs. |
| >PLMN Identity | M | | 9.3.3.5 | |
| . . . | . . . | . . . | . . . | . . . |

End Extract from 38.413

### RA Report

Other embodiments herein are applicable where SON reports include RA reports as described below. The UE generates and logs information related to the random access procedure and stores it in a list upon each successful Random Access attempt. The UE is requested to report this information to the network through the UEINFORMATIONREQUEST message as defined in TS 38.331 V17.1.0.

Begin Extract from 38.331

### 5.7.10.4 Actions Upon Successful Completion of a Random-Access Procedure or on Successful or Unsuccessful Completion of a Procedure for Request of On-Demand System Information

Upon successfully performing random-access procedure initialized with 4-step or 2-step RA type, or upon failed or successfully completed on-demand system information acquisition procedure, the UE shall:
1> if the RPLMN or the PLMN selected by upper layers (see TS 24.501 v17.7.1) from the PLMN(s) included in the plmn-IdentityList in SIB1 is not included in plmn-IdentityList stored in a non-empty VarRA-Report:
2> clear the information included in VarRA-Report,
1> if the number of RA-Report entries stored in the ra-ReportList in VarRA-Report is less than maxRAReport:
2> if the number of PLMN entries in plmn-IdentityList stored in VarRA-Report is less than maxPLMN; or
2> if the number of PLMN entries in plmn-IdentityList stored in VarRA-Report is equal to maxPLMN and the list of EPLMNs is subset of or equal to the plmn-IdentityList stored in VarRA-Report.
3> append the following contents associated to the successfully completed random-access procedure as a new entry in the VarRA-Report:
   4> if the list of EPLMNs has been stored by the UE:
      5> set the plmn-IdentityList to include the list of EPLMNs stored by the UE (i.e. includes the RPLMN) without exceeding the limit of maxPLMN;
   4> else:
      5> set the plmn-Identity, in plmn-IdentityList, to the PLMN selected by upper layers (see TS 24.501 [23]) from the PLMN(s) included in the plmn-IdentityInfoList in SIB1;
   4> set the cellld to the global cell identity and the tracking area code, if available, otherwise to the physical cell identity and carrier frequency of the cell in which the corresponding random-access preamble was transmitted;
   4> if the corresponding random-access procedure was performed on an SCell of MCG:
      5> set the spCellld to the global cell identity of the PCell;
   4> if the corresponding random-access procedure was performed on an SCell of SCG:
      5> set the spCellld to the global cell identity of the PSCell;
   4> set the raPurpose to include the purpose of triggering the random-access procedure;
   4> set the ra-InformationCommon as specified in clause 5.7.10.5.

The UE may discard the random access report information, i.e. release the UE variable VarRA-Report, 48 hours after the last successful random access procedure related information is added to the VarRA-Report.

End Extract from 38.331

Some embodiments herein address certain challenge(s) in this context.

A UE may perform mobility between PN and NPN networks. The UE may log SON reports in a PN networks (e.g., RLF report or a RA report) and upon mobility to the NPN network, it may log new SON reports (e.g., a new RLF report collected upon a failure occurred in the NPN). According to current 3GPP specifications, the UE would discard a previously stored RLF Report, e.g., collected while in PM, upon the occurrence of an RLF and the generation of a new RLF Report in an NPN network. Therefore, the problem is that an operator managing an NPN network (which may be different from an operator managing a PN network) is not able to collect an RLF Report related to the NPN network if the UE enters a PN network, and if a new RLF Report is generated. In fact, a UE implementation may even discard the RLF Report if the UE moves from a PN to an SNPN, for which the UE would have to re-register.

For example, as part of 3GPP TS 38.331 (version 17.1.0), the UE stores a single RLF report in a single variable when a failure occurs, and then sends it to the network upon network request. If the RLF report has not been retrieved and the UE experiences another RLF, the UE deletes the RLF report and creates a new one. Consider that the UE can have subscriptions to multiple networks, i.e., a combination of public network, SNPN or PNI-NPN. (The current 3GPP specifications only support single SNPN subscription but that may change in the future.) Although SNPN does not support mobility to other SNPNs or public networks, it is possible that it experiences RLF in SNPN and then registers in the public network and experiences an RLF again. This is also possible vice versa.

Such a scenario leads to loss of information in the SON reports e.g., RLF report is overwritten.

A similar problem occurs also for other reports, such as Random Access Channel (RACH) Reports and Connection Establishment Failure Reports. Namely, if these reports are collected for an NPN they could be either discarded upon re-registration by the UE to a new network, e.g., a PN or an SNPN, or they may be overwritten in case more reports of the same types are produced.

Some non-limiting example of SON reports are RLF report, RA Report, Successful Handover Report (SHR), Successful PSCell Report (SPR) or any other report collected/logged from/by the UE for network optimization.

Similarly, the loss of SON reports associated to an NPN prevents the operator from knowing important information that might help in optimizing the NPN network.

Certain aspects of the disclosure and their embodiments may provide solutions to these or other challenges. Some embodiments herein provide solutions performed by the wireless terminal, so-called User Equipment (UE), capable of mobility between PN and NPN networks, to prevent SON report(s) loss via the following methods:
Method 1: UE stores SON reports (e.g., RLF report) created as the consequence of an event that occurred in an NPN network in a new/separate variable (e.g., not in the existing VarRLF-Report). The UE keeps such new NPN-versions of the SON reports for a limited amount of time, so that the network can retrieve the reports. In one embodiment, the reports can be retrieved when the UE moves back to the NPN where the reports were generated.
Method 2: UE stores multiple SON reports (e.g., multiple RLF reports) up to a maximum number with unique reports for each RLF occurrence. Such reports may be labeled with indications that help deduce whether the report is related to events that occurred in an NPN. In this way, the network is able to retrieve reports selectively. For example, the network may be able to request the UE to report only the reports relative to an NPN. If the network retrieves the full list of reports, the indication that the report is related to a specific NPN, complemented by an identifier for the NPN, may help the network forwarding the report to the NPN where the event triggering the report originated.
Method 3: UE stores multiple RLF reports, with one list per network. Similar to Method 2, such lists may be labeled with indications that help deduce whether the list is related to events that occurred in an NPN or in a PN. In this way, the network is able to retrieve reports lists selectively. For example, the network may be able to request the UE to report only the reports relative to an NPN. If the network retrieves all available lists, the indication that a list of reports is related to a specific NPN, complemented by an identifier for the NPN, may help the network forwarding the list of reports to the NPN where the event triggering the reports originated.

Other embodiments herein propose different methods to notify the network about the availability of the SON reports to the network.

Generally, some embodiments herein may include the following steps.
Step 1: The UE has subscription to multiple networks. This can be a combination of public networks, PNI-NPN networks, and SNPN networks.
Step 2: The UE is subject to an event that generates an associated report, e.g., it experiences RLF when it is connected in the first network and generates an RLF report.
Step 3: The UE connects to the second network after disconnecting from the first network.
Step 4: While connected to the second network, the UE is subject to a new event for which another report, e.g., a new RLF report, is generated. The UE ensures no loss of information by storing the new report generated in the second network by means of the different methods described herein.
Step 5: The UE sends the report(s) generated while in the second network, e.g., RLF report(s) to the serving network. In some embodiments, the reports may be signalled to the first network and then forwarded from the first to the second network. In other embodiments, the reports may be signalled to the second network, upon connection by the UE to the second network.

Certain embodiments may provide one or more of the following technical advantage(s). Some embodiments herein mitigate loss of SON reports relative to different networks such as NPN networks; namely, in some embodiments, in the case where multiple reports are generated for different types of networks, the UE stores the reports on a per type of network basis, so that the reports are retrievable by the network.

### SON Report Storing

Consider now different methods to store multiple SON reports, e.g., RLF/RA reports, at the UE so as to prevent loss of SON related information.

### Method 1: UE Stores SON Reports Related to the NPN Network Under a New Variable

In one embodiment, the UE stores the SON Reports, e.g., RLF/RA reports, related to NPN networks under a new variable (e.g., VarRLF-ReportNPN or VarRA-ReportListNPN) that is different from the one already standardized and used for current SON reports related to the public network.

In one embodiment, the UE stores the SON Reports, e.g., RLF/RA reports, related to NPN networks in a new variable under the one already standardized and used for reports related to the public network.

In a dependent embodiment, the UE stores, together with the reports collected in a specific NPN, an identifier for the NPN where the reports were generated. Such Identifier may be for example an SNPN identifier (Namely PLMN+NID), a NID, a PLMN plus a CAG, a CAG, or the like.

In a dependent embodiment, if reports have been generated in different private networks, each report or list of reports may contain the NPN network identifier for the private network where the list of reports has been generated.

In a dependent embodiment, the list of reports associated to an NPN is further divided into sub lists, where each sublist contains only one type of report. For example, one sublist contains RLF Reports, another sublist contains RACH reports, etc.

Method 1 accordingly exemplifies embodiments described in FIG. 2, Embodiments A1-A34, Embodiments AA1-AA7, Embodiments AA16-AA26, and Embodiments AA35-AA41 herein. In this case, the data structures 18A, 18B in FIG. 2 are represented by variables (e.g., VarRLF-ReportNPN for NPN and VarRLF-Report for PN).

### Method 2: UE Stores Multiple Reports, e.g., RLF/RA Reports, Up to a Maximum Number, With Unique Reports for Each Event Occurrence in Different Network Types

In one embodiment, the UE stores a list of reports and stores them up to a pre-determined maximum number. These reports are stored in a list irrespective of the network where the report was generated.

In one embodiment, the list contains only reports of the same type, for example RLF reports, where such RLF reports may be generated within a PN or an NPN.

In a dependent embodiment, the UE stores, for each report collected in a specific list, an identifier for the NPN where the reports were generated (assuming the report was generated in an NPN network). Such Identifier may be for example an SNPN identifier (Namely PLMN+NID), a NID, a PLMN plus a CAG, a CAG, or the like.

Method 2 accordingly exemplifies embodiments described in FIG. 3, Embodiments AA1-AA15, Embodiments AA16-AA23, and Embodiments AA35-AA41 herein. In this case, the data structure 18 in FIG. 3 is represented by a variable (e.g., VarRLF-Report common for both NPN and PN).

### Method 3: UE Stores Multiple Reports, One Per Network

In one embodiment, the UE stores the reports, e.g., RLF/RACH reports, in separate lists where each list has an identifier that denotes which type of network the report pertains to. Namely, the lists in question are per network, with a granularity of, for example per PN, PNI-NPN, SNPN, or in general NPN, and the list contains different types of reports, e.g., RLF Reports, RACH Reports, CEF Reports . . . .

In a dependent embodiment, the UE stores, for each list, an identifier for the NPN where the reports in the list were generated (assuming the report was generated in an NPN network). Such Identifier may be for example an SNPN identifier (Namely PLMN+NID), a NID, a PLMN plus a CAG, a CAG.

Method 3 accordingly exemplifies embodiments described in FIG. 2, Embodiments A1-A34, Embodiments AA1-AA7, Embodiments AA16-AA26, and Embodiments AA35-AA41 herein. In this case, the data structures 18A, 18B in FIG. 2 are represented by different lists.

### Example Implementations

### Method 1:

Begin Extract from 38.331

npn-RLF-Report
The UE variable npn-RLF-Report includes the radio link failure information or handover
failure information in an NPN network.

npnRLF-Report UE variable

-- ASN1START
-- TAG-VARRLF-REPORT-START

| | |
|---|---|
| npn-RLF-Report-r16 ::= | SEQUENCE { |
| rlf-Report-r16 | RLF-Report-r16, |
| npn-IdentityList-r16 | NPN-Identity-r16, |

}
-- TAG-VARRLF-REPORT-STOP
-- ASN1STOP
ALTERNATIVE IMPLEMENTATION
npn-RLF-Report
The UE variable npn-RLF-Report includes the radio link failure information or handover
failure information in an NPN network.

npnRLF-Report UE variable

-- ASN1START
-- TAG-VARRLF-REPORT-START

| | |
|---|---|
| npn-RLF-Report-r16 ::= | SEQUENCE { |
| rlf-Report-r16 | RLF-Report-r16, |
| NPN-Identity-r16 ::= | CHOICE { |
| pni-npn-r16 | SEQUENCE { |
| plmn-Identity-r16 | PLMN-Identity, |
| cag-IdentityList-r16 | SEQUENCE (SIZE (1..maxNPN-r16)) OF CAG-IdentityInfo-r16 |

},

| | |
|---|---|
| snpn-r16 | SEQUENCE { |
| plmn-Identity-r16 | PLMN-Identity, |
| nid-List-r16 | SEQUENCE (SIZE (1..maxNPN-r16)) OF NID-r16 |

}
}

| CAG-IdentityInfo-r16 ::= | SEQUENCE { | |
|---|---|---|
| cag-Identity-r16 | BIT STRING (SIZE (32)), | |
| manualCAGselectionAllowed-r16 | ENUMERATED {true} | OPTIONAL -- |

Need R
}

| | |
|---|---|
| NID-r16 ::= | BIT STRING (SIZE (44)) |

}
-- TAG-VARRLF-REPORT-STOP
-- ASN1STOP

End Extract from 38.331
Begin Extract from 38.423

### 9.2.2.59 UE RLF Report

This IE contains the RLF Report to be transferred.

| IE/Group | | | IE type and | |
|---|---|---|---|---|
| Name | Presence | Range | reference | Semantics description |
| CHOICE type | M | | | |
| >NR | | | | |
| >>NR UE RLF | M | | OCTET | nr-RLF-Report-r16 IE contained in the |
| Report | | | STRING | UEInformationResponse message defined |
| Container | | | | in TS 38.331. |
| >LTE | | | | |
| >>LTE UE RLF | M | | OCTET | RLF-Report-r9 IE contained in the |
| Report | | | STRING | UEInformationResponse message defined |
| Container | | | | in TS 36.331 |
| > NPN | | | | |
| >> NPN UE | O | | OCTET | npn-RLF-Report IE contained in the |
| RLF Container | | | STRING | UEInformationResponse message defined |
| | | | | in TS 38.331. |

An alternative implementation for RACH report exchange is shown below to be added optionally.

### 9.1.3.25 Access and Mobility Indication

This message is sent by NG-RAN node, to transfer access and mobility related information to NG-RAN node₂.

Direction: NG-RAN node₁® NG-RAN node₂.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | ignore |
| RACH Report List | | 0 . . . 1 | | | YES | ignore |
| >RACH Report | | 1 . . . | | | EACH | ignore |
| List Item | | <maxnoofRACHReports> | | | | |
| >>RACH Report | O | | OCTET | RA-ReportList- | YES | ignore |
| Container | | | STRING | r16 IE as | | |
| | | | | defined in | | |
| | | | | subclause 6.2.2 | | |
| | | | | in TS 38.331. | | |
| >>UE Assistant | O | | NG-RAN | | YES | ignore |
| Identifier | | | node UE | | | |
| | | | XnAP ID | | | |
| | | | 9.2.3.16 | | | |
| > RACH Report | O | | | | | |
| List for NPN | | | | | | |
| Item | | | | | | |
| >>NPN RACH | O | | OCTET | RA- | YES | ignore |
| Report | | | STRING | npnReportList- | | |
| Container | | | | r18 IE as | | |
| | | | | defined in | | |
| | | | | subclause 6.x.x | | |
| | | | | in TS 38.331. | | |
| Successful HO | | 0 . . . 1 | | | YES | ignore |
| Report List | | | | | | |
| >Successful HO | | 1 . . . | | | — | |
| Report List Item | | <maxnoofSuccess- | | | | |
| | | fulHOReports> | | | | |
| >>Successful | O | | OCTET | | — | |
| HO Report | | | STRING | | | |
| Container | | | | | | |
| >Successful | | 1 . . . | | | — | |
| HO Report List | | <maxnoofSuccess- | | | | |
| for NPN Item | | fulnpnHOReports> | | | | |
| >>NPN | O | | OCTET | | — | |
| Successful HO | | | STRING | | | |
| Report | | | | | | |
| Container | | | | | | |

| Range bound | Explanation |
|---|---|
| maxnoofRACHReports | Maximum no. of RACH Reports, the |
| | maximum value is 64 |
| maxnoofSuccessfulHOReports | Maximum no. of Successful HO Reports, |
| | the maximum value is 64. |

End Extract from 38.423
Begin Extract from 38.413

### 9.3.3.37 Failure Indication Failure

This IE contains the failure indication to be transferred.

| | | | | |
|---|---|---|---|---|
| | | | IE type and | Semantics |
| IE/Group Name | Presence | Range | reference | description |

| | | |
|---|---|---|
| UE RLF Report | O | 9.3.3.41 |
| Container | | |
| UE NPN RLF | O | 9.3.3.x |
| Report Container | | |

### 9.3.3.41 UE NPN RLF Report Container

This IE contains the RLF Report to be transferred.

| | | | | |
|---|---|---|---|---|
| | | | IE type and | |
| IE/Group Name | Presence | Range | reference | Semantics description |

| | | | |
|---|---|---|---|
| NPN UE RLF Report | M | OCTET STRING | Nr-npn-RLF-Report-r16 |
| Container | | | IE contained in the |
| | | | UEInformationResponse |
| | | | message defined in TS |
| | | | 38.331. |

End Extract from 38.413

### SON Report Indication

Other embodiments herein include different notification procedures to indicate to the network about the availability of the SON report that relates to the NPN network.

In one embodiment, the UE indicates the availability of SON reports related to both PN and NPN to the current node(s) serving the UE.

In one embodiment, if the UE has both NPN related and PN related SON reports, it only indicates the availability of the report which the current serving node(s) belongs to. For example, if the UE is currently served by a NPN node, it only indicates the availability of the NPN related SON report.

In one embodiment, the UE indicates the availability of NPN related SON reports only if the UE is served by an NPN with an NPN identifier that matches the NPN identifier stored in the one or more NPN reports stored by the UE. As an example, if a UE has a SON report associated to a given PLMN ID+CAG, and if the UE is served by a cell with the same PLMN ID+CAG, the UE will flag the availability of an NPN SON report

In a dependent embodiment of the embodiments above, the UE may flag the availability of NPN reports with a per report type granularity. Namely, the UE may flag the availability of RLF Reports for NPN and/or RACH Reports for NPN and/or CEF reports for NPN and/or Successful HO Report for NPN and so on.

### SON Report Reporting

Upon receiving an indication of the availability of SON reports related to an NPN, the serving RAN may trigger collection of the SON Reports. The following embodiments are foreseen.

In one embodiment, the serving RAN will collect the SON reports only if they are associated to an NPN that is served by the serving RAN cells where the UE is connected.

In one embodiment, the serving RAN will collect the SON reports only if the serving RAN is part of an NPN network and if the reports are associated to an NPN.

In one embodiment, the serving RAN will collect all reports available at the UE, independently of whether they are associated to a PN or NPN network.

As a consequence of receiving the SON reports, the serving RAN may carry out the following.

In one embodiment, if the SON reports collected are associated to an NPN also served by the serving RAN, the serving RAN may use these reports to optimize network configurations such as mobility, RACH configurations, and/or coverage.

In one embodiment, if the SON reports collected are associated to an NPN not served by the serving RAN, the serving RAN may forward the reports to the target RAN, namely the RAN serving the NPN to which the reports are associated. The target RAN may use these reports to optimize network configurations such as mobility, RACH configurations, and/or coverage.

In one dependent embodiment, the reports may be signalled to the target RAN via a direct interface between the serving RAN and the target RAN, e.g., the Xn interface.

In a dependent embodiment, the reports may be signalled to the target RAN via signalling over the core network (CN), where a CN node may forward the reports received from the serving RAN to the target RAN.

In a dependent embodiment, the reports may be signalled to the target RAN via signalling over the CN, where a CN node may forward the reports received from the serving RAN to a different CN node in the same network, which will then signal them to the target RAN.

In a dependent embodiment, the reports may be signalled to the target RAN via signalling over the CN, where a CN node may forward the reports received from the serving RAN to a different CN node in a different network and where the CN node in the target network will forward the reports to the target RAN.

In a dependent embodiment, the serving RAN may signal the reports to a different system, e.g., the Operations and Maintenance (OAM). The OAM will then be in charge of signalling such reports to nodes/systems that can forward them to the target RAN.

Note that the methods herein are applicable individually to either RLF reports or RA reports or any other SON reports even though in some parts of this description they have been written for RLF and RA reports for simplicity. SON reports include reports generated by the UE as consequence of specific events such as RLF, handover failures, failures in PSCells, Connection Establishment Failures, RACH access, and successful mobility.

According to some embodiments herein, a UE avoids storing only one RLF report and/or avoids deleting an RLF report before it is retrieved by the communication network or before another RLF occurs. Some embodiments do the same for other reports such as Connection Establishment Failures (CEF), SCG failure reports, and Successful Handover Reports.

Some embodiments herein are applicable to any SON related reports generated by the UE that has a subscription to both public and private networks.

The terms private networks/NPN and SNPN/PNI-NPN nodes have been used interchangeably. PNI-NPN network herein covers the scenario when a cell advertises a PLMN+CAG in NPN-Identity in System Information Block #1 (SIB1). SNPN network herein covers the scenario when a cell advertises a PLMN+NID in NPN-Identity in SIB1.

The term “network where the report was generated” corresponds to the network where the event that triggered the report occurred. Namely, this network is the network that would need to receive the report in order to debug the issue that caused the event for which the report was generated.

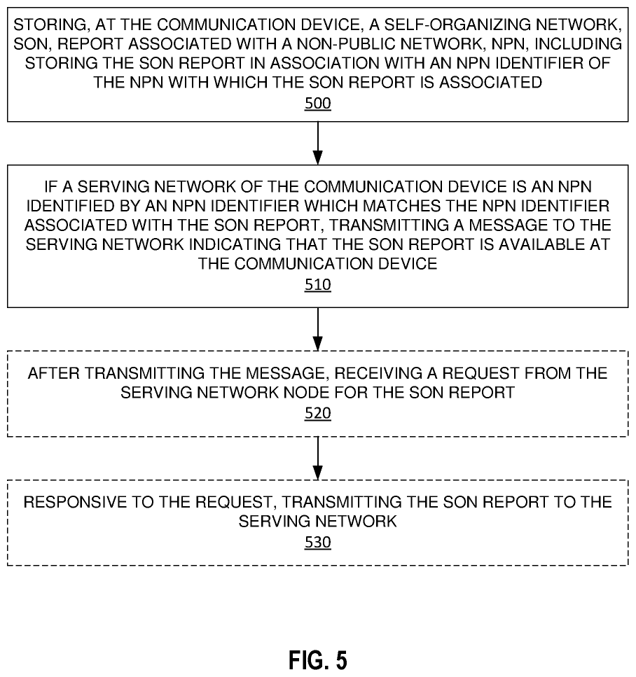

In view of the modifications and variations herein, FIG. 5 depicts a method performed by a communication device 12 in accordance with particular embodiments. The method includes storing, at the communication device 12, a self-organizing network, SON, report 16 associated with a non-public network, NPN, including storing the SON report 16 in association with an NPN identifier of the NPN with which the SON report 16 is associated (Block 500). The method also includes, if a serving network of the communication device 12 is an NPN identified by an NPN identifier which matches the NPN identifier associated with the SON report 16, transmitting a message to the serving network indicating that the SON report 16 is available at the communication device 12 (Block 510),

In some embodiments, the method also includes, after transmitting the message, receiving a request from the serving network node for the SON report 16 (Block 520).

In some embodiments, the method also includes, responsive to the request, transmitting the SON report 16 to the serving network (Block 530).

In some embodiments, the method also includes checking if the serving network of the communication device 12 is an NPN identified by an NPN identifier which matches the NPN identifier associated with the SON report 16. In some embodiments, transmitting the message comprises transmitting the message if, according to said checking, the serving network of the communication device 12 is an NPN identified by an NPN identifier which matches the NPN identifier associated with the SON report 16.

In some embodiments, the NPN is a standalone NPN, and the NPN identifier is a combination of a Public Land Mobile Network (PLMN) identifier and a Network ID (NID).

In some embodiments, the SON report 16 includes radio link failure information or handover failure information in the NPN.

In some embodiments, storing the NPN report in association with an NPN identifier of the NPN with which the SON report 16 is associated comprises storing the NPN identifier in the NPN report.

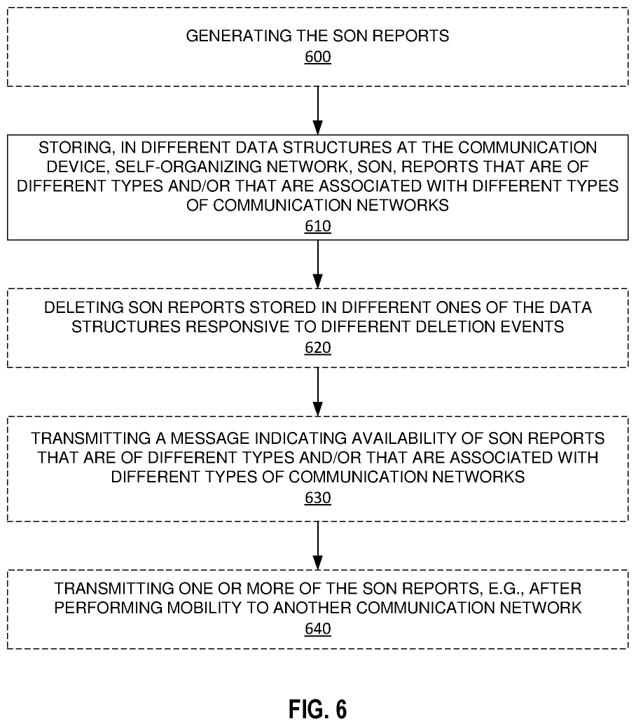

FIG. 6 depicts a method performed by a communication device 12 in accordance with other particular embodiments. The method includes storing, in different data structures 18A, 18B at the communication device 12, self-organizing network, SON, reports 16A-1 . . . 16A-N, 16B-1 . . . 16B-M that are of different types and/or that are associated with different types of communication networks (Block 610).

In some embodiments, the method includes generating the SON reports 16A-1 . . . 16A-N, 16B-1 . . . 16B-M (Block 600).

In some embodiments, the method includes deleting SON reports 16A-1 . . . 16A-N, 16B-1 . . . 16B-M stored in different ones of the data structures 18A, 18B responsive to different deletion events (Block 620). For example, the data structures 18A, 18B may be associated with different types of communication networks, and the different deletion events may be respectively associated with the different types of communication networks.

In some embodiments, the method includes transmitting a message indicating availability of SON reports 16A-1 . . . 16A-N, 16B-1 . . . 16B-M that are of different types and/or that are associated with different types of communication networks (Block 630).

In some embodiments, the method includes transmitting one or more of the SON reports 16A-1 . . . 16A-N, 16B-1 . . . 16B-M, e.g., after performing mobility to another communication network (Block 640).

In some embodiments, said storing comprises storing, in the different data structures 18A, 18B, SON reports 16A-1 . . . 16A-N, 16B-1 . . . 16B-M that are of different types.

In some embodiments, the different data structures 18A, 18B are specific for and/or dedicated for SON reports 16A-1 . . . 16A-N, 16B-1 . . . 16B-M of the different respective types.

In some embodiments, said storing comprises storing, in the different data structures 18A, 18B, SON reports 16A-1 . . . 16A-N, 16B-1 . . . 16B-M that are associated with different types of communication networks.

In some embodiments, the different data structures 18A, 18B are specific for and/or dedicated for SON reports 16A-1 . . . 16A-N, 16B-1 . . . 16B-M associated with the different respective types of networks.

In some embodiments, the different types of communication networks include a public network and a non-public network such that at least one of the different data structures 18A, 18B is specific for and/or dedicated for SON reports 16A-1 . . . 16A-N, 16B-1 . . . 16B-M associated with public networks and at least one of the different data structures 18A, 18B is specific for and/or dedicated for SON reports 16A-1 . . . 16A-N, 16B-1 . . . 16B-M associated with non-public networks.

In some embodiments, said storing comprises simultaneously storing SON reports 16A-1 . . . 16A-N, 16B-1 . . . 16B-M across the different data structures 18A, 18B.

In some embodiments, said storing comprises storing SON reports 16A-1 . . . 16A-N, 16B-1 . . . 16B-M of the same type in different data structures 18A, 18B associated with different respective types of communication networks. In some embodiments, the SON reports 16A-1 . . . 16A-N, 16B-1 . . . 16B-M of the same type are radio link failure, RLF, reports. In some embodiments, the SON reports 16A-1 . . . 16A-N, 16B-1 . . . 16B-M of the same type are connection establishment failure reports, secondary cell group failure reports, or successful handover reports.

In some embodiments, said storing comprises storing, in each data structure 18A, 18B, the latest N SON reports, where N>1. In some embodiments, each SON report 16A-1 . . . 16A-N, 16B-1 . . . 16B-M is stored until the SON report 16A-1 . . . 16A-N, 16B-1 . . . 16B-M is fetched by a communication network or until a storage expiration time expires, whichever occurs first.

In some embodiments, the stored SON reports 16A-1 . . . 16A-N, 16B-1 . . . 16B-M report respective occurrences of an SON event.

In some embodiments, the different data structures 18A, 18B are different variables or different lists.

In some embodiments, each of the multiple data structures 18A, 18B is associated with a respective network identifier. In some embodiments, the network identifier identifies a communication network associated with the data structure 18A, 18B. In other embodiments, the network identifier alternatively or additionally identifies a respective network type identifier identifying a type of a communication network associated with the data structure 18A, 18B. In some embodiments, the network type identifier identifies a communication network as being either a public network or a non-public network.

In some embodiments, each of the multiple data structures 18A, 18B is common to multiple types of SON reports 16A-1 . . . 16A-N, 16B-1 . . . 16B-M.

In some embodiments, storing multiple SON reports 16A, 16B comprises, while in a first communication network, generating and storing one or more first SON reports 16A, 16B in a first data structure 18A of the different data structures 18A, 18B. In this case, storing multiple SON reports 16A, 16B further comprises performing mobility from the first communication network to a second communication network. In this case, storing multiple SON reports 16A, 16B further comprises, while in the second communication network, generating and storing one or more second SON reports 16A, 16B in a second data structure 18B of the different data structures 18A, 18B, without deleting or overwriting the one or more first SON reports 16A, 16B stored in the first data structure 18A. In some embodiments, the first and second communication networks are different types of communication networks. In some embodiments, one of the first and second communication networks is a public network and the other of the first and second communication networks is a non-public network. In some embodiments, performing mobility from the first communication network to the second communication network comprises disconnecting from the first communication network and connecting to the second communication network after disconnecting from the first communication network. In some embodiments, the method further comprises, after performing mobility to the second communication network, transmitting the one or more first SON reports 16A-1 . . . 16A-N and/or the one or more second SON reports. In some embodiments, the one or more first SON reports 16A-1 . . . 16A-N and the one or more second SON reports 16B-1 . . . 16B-M are each the same type of SON report. In some embodiments, the one or more first SON reports 16A-1 . . . 16A-N and the one or more second SON reports 16B-1 . . . 16B-M are each an RLF report.

In some embodiments, the SON reports 16 are associated with different types of communication networks that include a first type and a second type. In this case, the method further comprises transmitting, to a network node, a message indicating availability of only one or more SON reports 16 associated with the first type or the second type of communication network depending respectively on whether the network node belongs to the first type or the second type of communication network.

In some embodiments, the SON reports 16 are associated with different communication networks. In this case, the method further comprises transmitting, to a network node, a message indicating availability of only one or more SON reports 16 associated with a communication network to which the network node belongs.

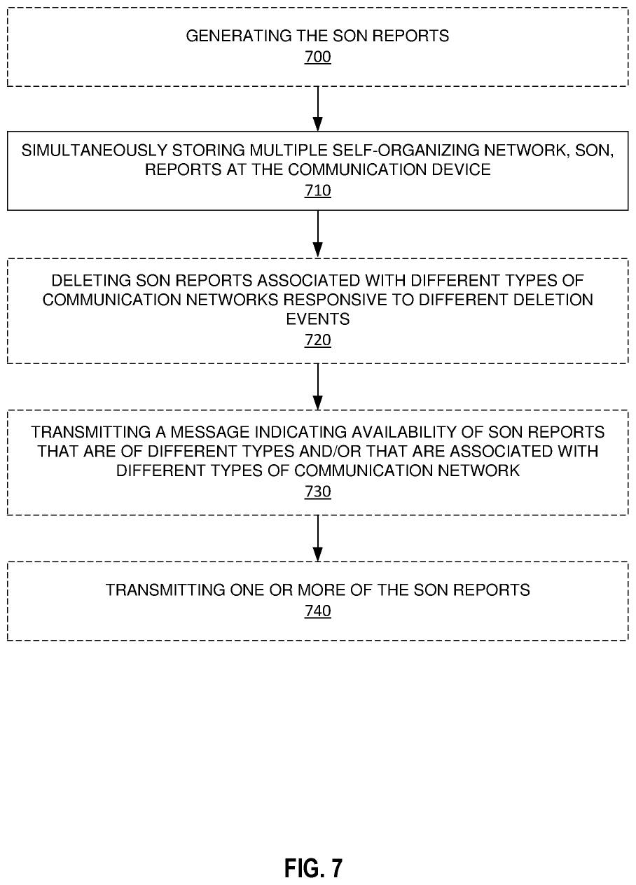

FIG. 7 depicts a method performed by a communication device 12 in accordance with other particular embodiments. The method includes simultaneously storing multiple self-organizing network, SON, reports 16 at the communication device 12 (Block 710).

In some embodiments, the method alternatively or additionally includes generating the SON reports 16 (Block 700).

In some embodiments, the method alternatively or additionally includes deleting SON reports 16 associated with different types of communication networks responsive to different deletion events (Block 720).

In some embodiments, the method alternatively or additionally includes transmitting a message indicating availability of SON reports 16 that are of different types and/or that are associated with different types of communication networks (Block 730).

In some embodiments, the method alternatively or additionally includes transmitting one or more of the SON reports 16 (Block 740).

In some embodiments, simultaneously storing multiple SON reports 16 at the communication device 12 comprises simultaneously storing, at the communication device 12, multiple SON reports 16 of the same type. In some embodiments, the multiple SON reports 16 of the same type are multiple radio link failure, RLF, reports. In some embodiments, the multiple SON reports 16 of the same type are multiple connection establishment failure reports, multiple secondary cell group failure reports, or multiple successful handover reports.

In some embodiments, simultaneously storing multiple SON reports 16 at the communication device 12 comprises simultaneously storing, at the communication device 12, the latest N SON reports 16, where N>1.

In some embodiments, simultaneously storing multiple SON reports 16 at the communication device 12 comprises simultaneously storing, at the communication device 12, the latest N SON reports, where N>1. In some embodiments, each SON report 16 is stored until the SON report 16 is fetched by a communication network or until a storage expiration time expires, whichever occurs first.

In some embodiments, the simultaneously stored SON reports 16 report respective occurrences of an SON event.

In some embodiments, simultaneously storing multiple SON reports 16 at the communication device 12 comprises simultaneously storing the multiple SON reports 16 in a data structure 18 at the communication device 12. In some embodiments, the data structure 18 is a variable or a list. In some embodiments, the data structure 18 is common to multiple types of communication networks such that the multiple SON reports 16 simultaneously stored in the data structure 18A include at least some SON reports 16 for different types of communication networks. In some embodiments, the different types of communication networks include a public network and a non-public network. In some embodiments, the data structure 18 is common to multiple communication networks such that the multiple SON reports 16 simultaneously stored in the data structure 18 include at least some SON reports 16 for different communication networks. In some embodiments, each of the multiple SON reports 16 stored in the data structure 18 is stored with a respective network identifier identifying a communication network associated with the SON report 16. In other embodiments, each of the multiple SON reports 16 stored in the data structure 18 is alternatively or additionally stored with a respective network type identifier identifying a type of a communication network associated with the SON report 16. In some embodiments, the network type identifier identifies a communication network as being either a public network or a non-public network. In some embodiments, the data structure 18 is specific to a specific type of SON report 16 such that the multiple SON reports 16 simultaneously stored in the data structure 18 include multiple SON reports 16 of the specific type.

In some embodiments, simultaneously storing multiple SON reports 16 at the communication device 12 comprises simultaneously storing the multiple SON reports 16 across multiple data structures 18A, 18B at the communication device 12. In some embodiments, the multiple data structures 18A, 18B are multiple variables or multiple lists. In some embodiments, the multiple data structures 18A, 18B are specific to different respective types of communication networks. In some embodiments, the different respective types of communication networks include a public network and a non-public network. In some embodiments, the multiple data structures 18A, 18B are specific to different respective communication networks. In some embodiments, each of the multiple data structures 18A, 18B is associated with a respective network identifier identifying a communication network associated with the data structure 18A, 18B. In other embodiments, each of the multiple data structures 18A, 18B is alternatively or additionally associated with a respective network type identifier identifying a type of a communication network associated with the data structure 18A, 18B. In some embodiments, the network type identifier identifies a communication network as being either a public network or a non-public network. In some embodiments, each of the multiple data structures 18A, 18B is common to multiple types of SON reports 16. In some embodiments, simultaneously storing the multiple SON reports 16 across the multiple data structures 18A, 18B at the communication device 12 comprises simultaneously storing multiple SON reports 16 in at least one of the multiple data structures 18A, 18B. In some embodiments, the method further comprises deleting SON reports 16 stored in different ones of the data structures 18A, 18B responsive to different deletion events. In some embodiments, the data structures 18A, 18B are associated with different types of communication networks, and wherein the different deletion events are respectively associated with the different types of communication networks. In some embodiments, the different types of communication networks include a public network and a non-public network.

In some embodiments, simultaneously storing multiple SON reports 16 comprises, while in a first communication network, generating and storing one or more first SON reports 16 at the communication device 12. In this case, simultaneously storing multiple SON reports 16 further comprises performing mobility from the first communication network to a second communication network. In this case, simultaneously storing multiple SON reports 16 further comprises, while in the second communication network, generating and storing one or more second SON reports 16 at the communication device 12, without deleting or overwriting the one or more first SON reports 16 stored at the communication device 12 such that the one or more second SON reports 16 are simultaneously stored at the communication device 12 with the one or more first SON reports 16. In some embodiments, the first and second communication networks are different types of communication networks. In some embodiments, one of the first and second communication networks is a public network and the other of the first and second communication networks is a non-public network. In some embodiments, performing mobility from the first communication network to the second communication network comprises disconnecting from the first communication network and connecting to the second communication network after disconnecting from the first communication network. In some embodiments, the method further comprises, after performing mobility to the second communication network, transmitting the one or more first SON reports 16A-1 . . . 16A-N and/or the one or more second SON reports 16B-1 . . . 16B-M. In some embodiments, the one or more first SON reports 16A-1 . . . 16A-N and the one or more second SON reports 16B-1 . . . 16B-M are each the same type of SON report. In some embodiments, the one or more first SON reports 16A-1 . . . 16A-N and the one or more second SON reports 16B-1 . . . 16B-M are each an RLF report.

In some embodiments, the method further comprises deleting SON reports 16 associated with different types of communication networks responsive to different deletion events, wherein the different deletion events are respectively associated with the different types of communication networks. In some embodiments, the different types of communication networks include a public network and a non-public network.

In some embodiments, the method further comprises transmitting a message indicating availability of SON reports 16 that are of different types and/or that are associated with different types of communication networks.

In some embodiments, the SON reports 16 are associated with different types of communication networks that include a first type and a second type. In this case, the method further comprises transmitting, to a network node, a message indicating availability of only one or more SON reports 16 associated with the first type or the second type of communication network depending respectively on whether the network node belongs to the first type or the second type of communication network.

In some embodiments, the SON reports 16 are associated with different communication networks. In this case, the method further comprises transmitting, to a network node, a message indicating availability of only one or more SON reports 16 associated with a communication network to which the network node belongs.

In some embodiments, the method further comprises transmitting one or more of the SON reports 16.

In some embodiments, the method further comprises generating the SON reports 16.

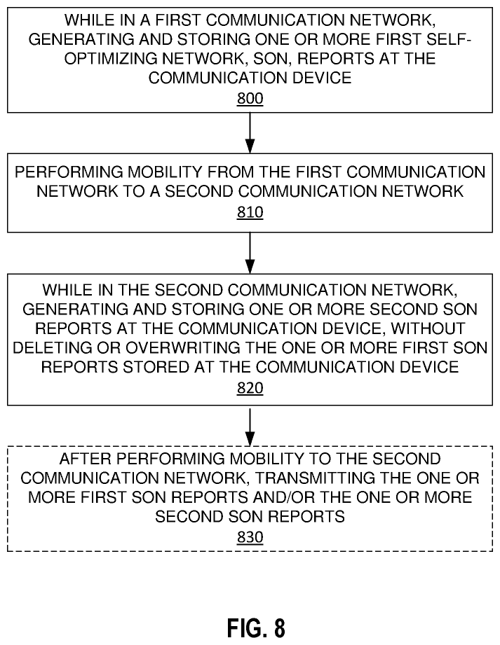

FIG. 8 depicts a method performed by a communication device 12 in accordance with other particular embodiments. The method includes, while in a first communication network 10A, generating and storing one or more first self-optimizing network, SON, reports 16A at the communication device 12 (Block 800). The method also includes performing mobility from the first communication network 10A to a second communication network 10B (Block 810). The method also includes, while in the second communication network 10B, generating and storing one or more second SON reports 16B at the communication device 12, without deleting or overwriting the one or more first SON reports 16A stored at the communication device 12 (Block 820).

In some embodiments, the method also includes, after performing mobility to the second communication network 10B, transmitting the one or more first SON reports 16A and/or the one or more second SON reports 16B (Block 830).

In some embodiments, the one or more second SON reports 16B are simultaneously stored at the communication device 12 with the one or more first SON reports 16A.

In some embodiments, the first and second communication networks 10A, 10B are different types of communication networks.

In some embodiments, one of the first and second communication networks 10A, 10B is a public network and the other of the first and second communication networks 10A, 10B is a non-public network.

In some embodiments, performing mobility from the first communication network 10A to the second communication network 10B comprises disconnecting from the first communication network 10A and connecting to the second communication network 10B after disconnecting from the first communication network 10A.

In some embodiments, the one or more first SON reports 16A and the one or more second SON reports 16B are each the same type of SON report.

In some embodiments, the one or more first SON reports 16A and the one or more second SON reports 16B are each an RLF report.

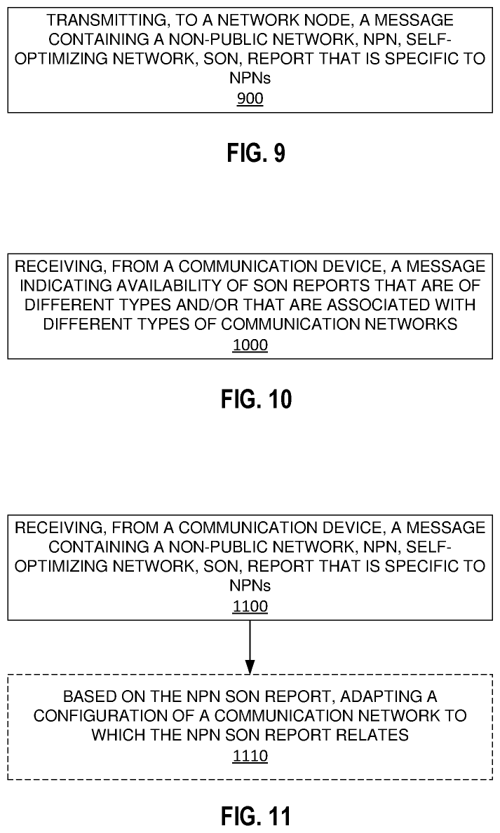

FIG. 9 depicts a method performed by a communication device 12 in accordance with other particular embodiments. The method includes transmitting, to a network node, a message containing a non-public network, NPN, self-optimizing network, SON, report 16 that is specific to NPNs (Block 900).

In some embodiments, the NPN SON report 16 is an NPN radio link failure, RLF, report. In some embodiments, the NPN RLF report includes radio link failure information or handover failure information in an NPN.

In some embodiments, the NPN SON report 16 is an NPN random access channel, RACH, report.

In some embodiments, the NPN SON report 16 includes an identifier of an NPN to which the NPN SON report 16 relates.

FIG. 10 depicts a method performed by a network node in accordance with other particular embodiments. The method includes receiving, from a communication device 12, a message indicating availability of SON reports 16 that are of different types and/or that are associated with different types of communication networks (Block 1000).

In some embodiments, the message indicates availability of SON reports 16 that are associated with different types of communication networks. In some embodiments, the different types of communication networks include a public network and a non-public network.

FIG. 11 depicts a method performed by a network node in accordance with other particular embodiments. The method includes receiving, from a communication device 12, a message containing a non-public network, NPN, self-optimizing network, SON, report 16 that is specific to NPNs (Block 1100). In some embodiments, the method also includes, based on the NPN SON report 16, adapting a configuration of a communication network to which the NPN SON report 16 relates (Block 1110).

In some embodiments, the NPN SON report 16 is an NPN radio link failure, RLF, report. In some embodiments, the NPN RLF report includes radio link failure information or handover failure information in an NPN. In some embodiments, the NPN SON report 16 is an NPN random access channel, RACH, report. In some embodiments, the NPN SON report 16 includes an identifier of an NPN to which the NPN SON report 16 relates. In some embodiments, the network node belongs to a different communication network than a communication network to which the NPN SON report 16 relates. In this case, the method further comprises forwarding the NPN SON report 16 to the communication network to which the NPN SON report 16 relates.

Embodiments herein also include corresponding apparatuses. Embodiments herein for instance include a communication device 12 configured to perform any of the steps of any of the embodiments described above for the communication device 12.

Embodiments also include a communication device 12 comprising processing circuitry and power supply circuitry. The processing circuitry is configured to perform any of the steps of any of the embodiments described above for the communication device 12. The power supply circuitry is configured to supply power to the communication device 12.

Embodiments further include a communication device 12 comprising processing circuitry. The processing circuitry is configured to perform any of the steps of any of the embodiments described above for the communication device 12. In some embodiments, the communication device 12 further comprises communication circuitry.

Embodiments further include a communication device 12 comprising processing circuitry and memory. The memory contains instructions executable by the processing circuitry whereby the communication device 12 is configured to perform any of the steps of any of the embodiments described above for the communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node configured to perform any of the steps of any of the embodiments described above for the network node.

Embodiments also include a network node comprising processing circuitry and power supply circuitry. The processing circuitry is configured to perform any of the steps of any of the embodiments described above for the network node. The power supply circuitry is configured to supply power to the network node.

Embodiments further include a network node comprising processing circuitry. The processing circuitry is configured to perform any of the steps of any of the embodiments described above for the network node. In some embodiments, the network node further comprises communication circuitry.

Embodiments further include a network node comprising processing circuitry and memory. The memory contains instructions executable by the processing circuitry whereby the network node is configured to perform any of the steps of any of the embodiments described above for the network node.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

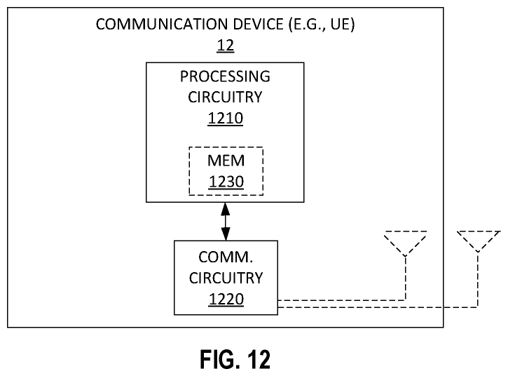

FIG. 12 for example illustrates a communication device 12 as implemented in accordance with one or more embodiments. As shown, the communication device 12 includes processing circuitry 1210 and communication circuitry 1220. The communication circuitry 1220 (e.g., radio circuitry) is configured to transmit and/or receive information to and/or from one or more other nodes, e.g., via any communication technology. Such communication may occur via one or more antennas that are either internal or external to the wireless communication device 12. The processing circuitry 1210 is configured to perform processing described above, e.g., in any of FIGS. 5-9, such as by executing instructions stored in memory 1230. The processing circuitry 1210 in this regard may implement certain functional means, units, or modules.

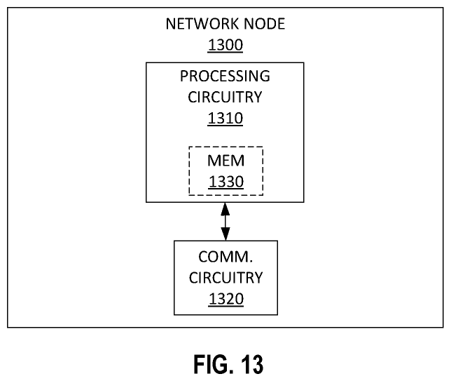

FIG. 13 illustrates a network node 1300 as implemented in accordance with one or more embodiments. As shown, the network node 1300 includes processing circuitry 1310 and communication circuitry 1320. The communication circuitry 1320 is configured to transmit and/or receive information to and/or from one or more other nodes, e.g., via any communication technology. The processing circuitry 1310 is configured to perform processing described above, e.g., in any of FIGS. 10-11, such as by executing instructions stored in memory 1330. The processing circuitry 1310 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

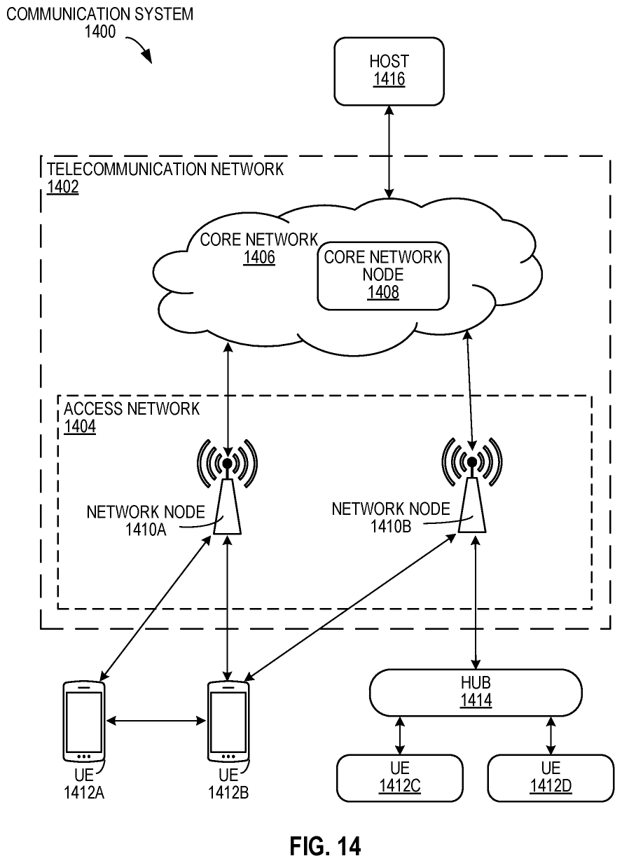

FIG. 14 shows an example of a communication system 1400 in accordance with some embodiments.

In the example, the communication system 1400 includes a telecommunication network 1402 that includes an access network 1404, such as a radio access network (RAN), and a core network 1406, which includes one or more core network nodes 1408. The access network 1404 includes one or more access network nodes, such as network nodes 1410a and 1410b (one or more of which may be generally referred to as network nodes 1410), or any other similar 3^{rd} Generation Partnership Project (3GPP) access node or non-3GPP access point. The network nodes 1410 facilitate direct or indirect connection of user equipment (UE), such as by connecting UEs 1412a, 1412b, 1412c, and 1412d (one or more of which may be generally referred to as UEs 1412) to the core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The UEs 1412 may be any of a wide variety of communication devices, Iding wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1402 is a cellular network that implements 3GPP standardized features. Accordingly, the telecommunications network 1402 may support network slicing to provide different logical networks to different devices that are connected to the telecommunication network 1402. For example, the telecommunications network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1414 communicates with the access network 1404 to facilitate indirect communication between one or more UEs (e.g., UE 1412c and/or 1412d) and network nodes (e.g., network node 1410b). In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a VR headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistenl or intermittent connection to the network node 1410b. The hub 1414 may also allow for a different communication scheme and/or schedule between the hub 1414 and UEs (e.g., UE 1412c and/or 1412d), and between the hub 1414 and the core network 1406. In other examples, the hub 1414 is connected to the core network 1406 and/or one or more UEs via a wired connection. Moreover, the hub 1414 may be configured to connect to an M2M service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410b. In other embodiments, the hub 1414 may be a non-dedicated hub—that is, a device which is capable of operating to route communications between the UEs and network node 1410b, but which is additionally capable of operating as a communication start and/or end point for certain data channels.

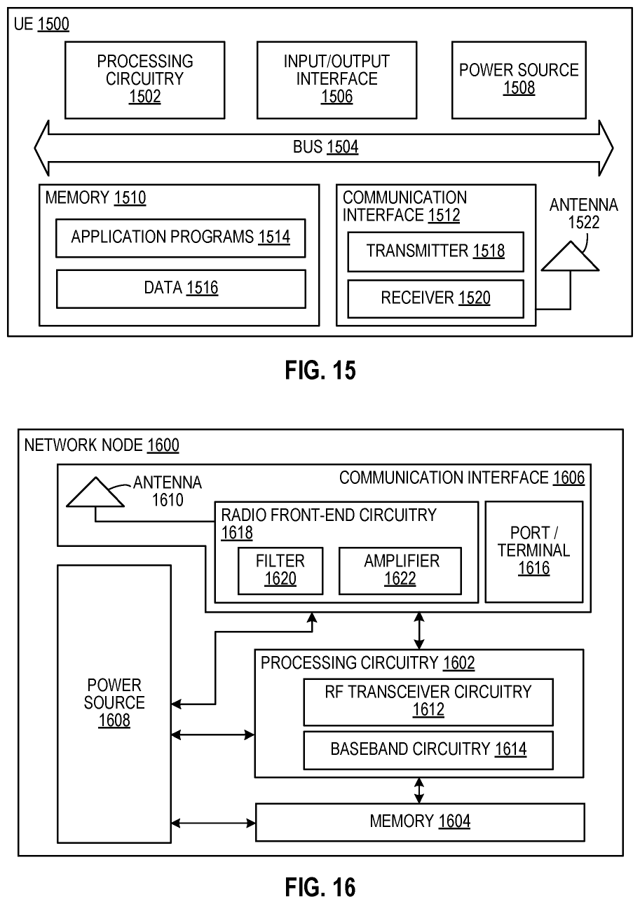

FIG. 15 shows a UE 1500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 151 includes processing circuitry IQ202 that is operatively coupled via a bus 1504 to an input/output interface 1506, a power source 1508, a memory 1510, a communication interface 1512, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry 1502 is configured to process instructions and data and may be configured to implement any sequential state machine operative to execute instructions stored as machine-readable computer programs in the memory 1510. The processing circuitry 1502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1502 may include multiple central processing units (CPUs).

In the example, the input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1508 is structured as a battery or battery pack. Other types of power sources, such as an external power source (e.g., an electricity outlet), photovoltaic device, or power cell, may be used. The power source 1508 may further include power circuitry for delivering power from the power source 1508 itself, and/or an external power source, to the various parts of the UE 1500 via input circuitry or an interface such as an electrical power cable. Delivering power may be, for example, for charging of the power source 1508. Power circuitry may perform any formatting, converting, or other modification to the power from the power source 1508 to make the power suitable for the respective components of the UE 1500 to which power is supplied.

The memory 1510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1510 includes one or more application programs 1514, such as an operating system, web browser application, a widget, gadget engine, or other application, and corresponding data 1516. The memory 1510 may store, for use by the UE 1500, any of a variety of various operating systems or combinations of operating systems.

The memory 1510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1510 may allow the UE 1500 to access instructions, application programs and the like, stored on transitory or non-transitory memory media, to off-load data, or to upload data. An article of manufacture, such as one utilizing a communication system may be tangibly embodied as or in the memory 1510, which may be or comprise a device-readable storage medium.

The processing circuitry 1502 may be configured to communicate with an access network or other network using the communication interface 1512. The communication interface 1512 may comprise one or more communication subsystems and may include or be communicatively coupled to an antenna 1522. The communication interface 1512 may include one or more transceivers used to communicate, such as by communicating with one or more remote transceivers of another device capable of wireless communication (e.g., another UE or a network node in an access network). Each transceiver may include a transmitter 1518 and/or a receiver 1520 appropriate to provide network communications (e.g., optical, electrical, frequency allocations, and so forth). Moreover, the transmitter 1518 and receiver 1520 may be coupled to one or more antennas (e.g., antenna 1522) and may share circuit components, software or firmware, or alternatively be implemented separately.

In the illustrated embodiment, communication functions of the communication interface 1512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1500 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 16 shows a network node 1600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1600 includes a processing circuitry 1602, a memory 1604, a communication interface 1606, and a power source 1608. The network node 1600 may be composed of multiple physically separate components (e.g., a NodeB component and a RNC component, or a BTS component and a BSC component, etc.), which may each have their own respective components. In certain scenarios in which the network node 1600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1600 may be configured to support multiple radio access technologies (RATs). In such embodiments, some components may be duplicated (e.g., separate memory 1604 for different RATs) and some components may be reused (e.g., a same antenna 1610 may be shared by different RATs). The network node 1600 may also include multiple sets of the various illustrated components for different wireless technologies integrated into network node 1600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1600.

The processing circuitry 1602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1600 components, such as the memory 1604, to provide network node 1600 functionality.

In some embodiments, the processing circuitry 1602 includes a system on a chip (SOC). In some embodiments, the processing circuitry 1602 includes one or more of radio frequency (RF) transceiver circuitry 1612 and baseband processing circuitry 1614. In some embodiments, the radio frequency (RF) transceiver circuitry 1612 and the baseband processing circuitry 1614 may be on separate chips (or sets of chips), boards, or units, such as radio units and digital units. In alternative embodiments, part or all of RF transceiver circuitry 1612 and baseband processing circuitry 1614 may be on the same chip or set of chips, boards, or units.

The memory 1604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions capable of being executed by the processing circuitry 1602 and utilized by the network node 1600. The memory 1604 may be used to store any calculations made by the processing circuitry 1602 and/or any data received via the communication interface 1606. In some embodiments, the processing circuitry 1602 and memory 1604 is integrated.

The communication interface 1606 is used in wired or wireless communication of signaling and/or data between a network node, access network, and/or UE. As illustrated, the communication interface 1606 comprises port(s)/terminal(s) 1616 to send and receive data, for example to and from a network over a wired connection. The communication interface 1606 also includes radio front-end circuitry 1618 that may be coupled to, or in certain embodiments a part of, the antenna 1610. Radio front-end circuitry 1618 comprises filters 1620 and amplifiers 1622. The radio front-end circuitry 1618 may be connected to an antenna 1610 and processing circuitry 1602. The radio front-end circuitry may be configured to condition signals communicated between antenna 1610 and processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of filters 1620 and/or amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface may comprise different components and/or different combinations of components.

In certain alternative embodiments, the network node 1600 does not include separate radio front-end circuitry 1618, instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes one or more ports or terminals 1616, the radio front-end circuitry 1618, and the RF transceiver circuitry 1612, as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the network node 1600 and connectable to the network node 1600 through an interface or port.

The antenna 1610, communication interface 1606, and/or the processing circuitry 1602 may be configured to perform any receiving operations and/or certain obtaining operations described herein as being performed by the network node. Any information, data and/or signals may be received from a UE, another network node and/or any other network equipment. Similarly, the antenna 1610, the communication interface 1606, and/or the processing circuitry 1602 may be configured to perform any transmitting operations described herein as being performed by the network node. Any information, data and/or signals may be transmitted to a UE, another network node and/or any other network equipment.

The power source 1608 provides power to the various components of network node 1600 in a form suitable for the respective components (e.g., at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g., the power grid, an electricity outlet) via an input circuitry or interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 16 for providing certain aspects of the network node's functionality, including any of the functionality described herein and/or any functionality necessary to support the subject matter described herein. For example, the network node 1600 may include user interface equipment to allow input of information into the network node 1600 and to allow output of information from the network node 1600. This may allow a user to perform diagnostic, maintenance, repair, and other administrative functions for the network node 1600.

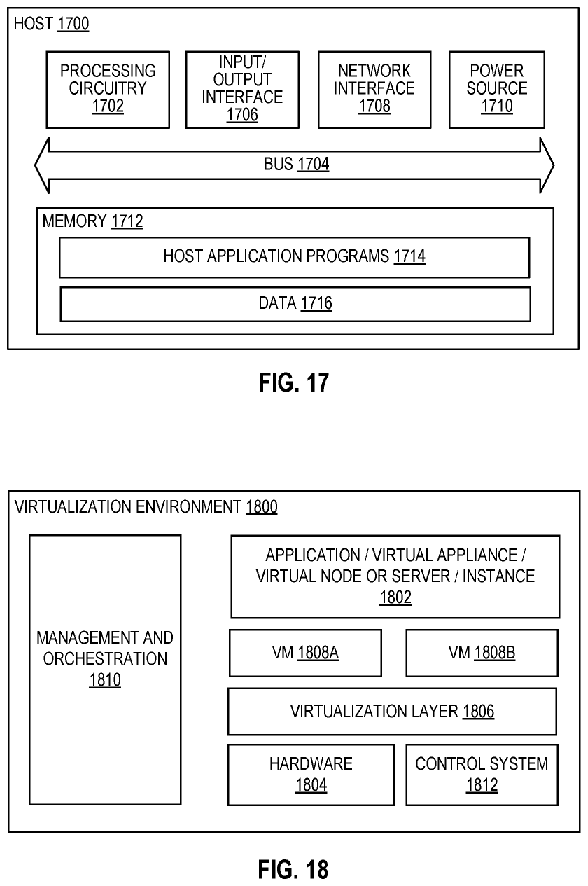

FIG. 17 is a block diagram of a host 1700, which may be an embodiment of the host 1416 of FIG. 14, in accordance with various aspects described herein. As used herein, the host 1700 may be or comprise various combinations hardware and/or software, including a standalone server, a blade server, a cloud-implemented server, a distributed server, a virtual machine, container, or processing resources in a server farm. The host 1700 may provide one or more services to one or more UEs.

The host 1700 includes processing circuitry 1702 that is operatively coupled via a bus 1704 to an input/output interface 1706, a network interface 1708, a power source 1710, and a memory 1712. Other components may be included in other embodiments. Features of these components may be substantially similar to those described with respect to the devices of previous figures, such as FIGS. 15 and 16, such that the descriptions thereof are generally applicable to the corresponding components of host 1700.

The memory 1712 may include one or more computer programs including one or more host application programs 1714 and data 1716, which may include user data, e.g., data generated by a UE for the host 1700 or data generated by the host 1700 for a UE.

Embodiments of the host 1700 may utilize only a subset or all of the components shown. The host application programs 1714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1714 may also provide for user authentication and licensing checks and may periodically report health, routes, and content availability to a central node, such as a device in or on the edge of a core network. Accordingly, the host 1700 may select and/or indicate a different host for over-the-top services for a UE. The host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1806 (also referred to as hypervisors or virtual machine monitors (VMMs)), provide VMs 1808a and 1808b (one or more of which may be generally referred to as VMs 1808), and/or perform any of the functions, features and/or benefits described in relation with some embodiments described herein. The virtualization layer 1806 may present a virtual operating platform that appears like networking hardware to the VMs 1808.

The VMs 1808 comprise virtual processing, virtual memory, virtual networking or interface and virtual storage, and may be run by a corresponding virtualization layer 1806. Different embodiments of the instance of a virtual appliance 1802 may be implemented on one or more of VMs 1808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1808 may be a software implementation of a physical machine that runs programs as if they were executing on a physical, non-virtualized machine. Each of the VMs 1808, and that part of hardware 1804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1808 on top of the hardware 1804 and corresponds to the application 1802.

Hardware 1804 may be implemented in a standalone network node with generic or specific components. Hardware 1804 may implement some functions via virtualization. Alternatively, hardware 1804 may be part of a larger cluster of hardware (e.g. such as in a data center or CPE) where many hardware nodes work together and are managed via management and orchestration 1810, which, among others, oversees lifecycle management of applications 1802. In some embodiments, hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1812 which may alternatively be used for communication between hardware nodes and radio units.

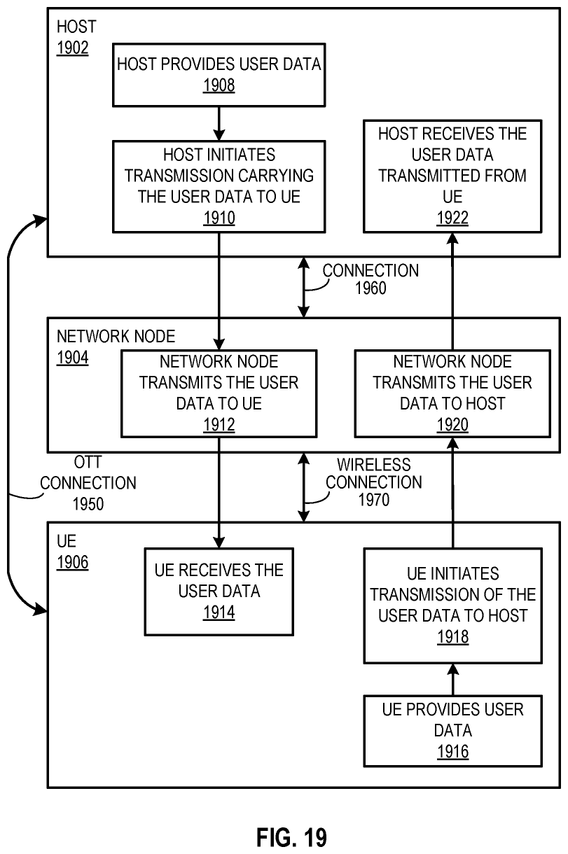

FIG. 19 shows a communication diagram of a host 1902 communicating via a network node 1904 with a UE 1906 over a partially wireless connection in accordance with some embodiments. Example implementations, in accordance with various embodiments, of the UE (such as a UE 1412a of FIG. 14 and/or UE 1500 of FIG. 15), network node (such as network node 1410a of FIG. 14 and/or network node 1600 of FIG. 16), and host (such as host 1416 of FIG. 14 and/or host 1700 of FIG. 17) discussed in the preceding paragraphs will now be described with reference to FIG. 19.

Like host 1700, embodiments of host 1902 include hardware, such as a communication interface, processing circuitry, and memory. The host 1902 also includes software, which is stored in or accessible by the host 1902 and executable by the processing circuitry. The software includes a host application that may be operable to provide a service to a remote user, such as the UE 1906 connecting via an over-the-top (OTT) connection 1950 extending between the UE 1906 and host 1902. In providing the service to the remote user, a host application may provide user data which is transmitted using the OTT connection 1950.

The network node 1904 includes hardware enabling it to communicate with the host 1902 and UE 1906. The connection 1960 may be direct or pass through a core network (like core network 1406 of FIG. 14) and/or one or more other intermediate networks, such as one or more public, private, or hosted networks. For example, an intermediate network may be a backbone network or the Internet.

The UE 1906 includes hardware and software, which is stored in or accessible by UE 1906 and executable by the UE's processing circuitry. The software includes a client application, such as a web browser or operator-specific “app” that may be operable to provide a service to a human or non-human user via UE 1906 with the support of the host 1902. In the host 1902, an executing host application may communicate with the executing client application via the OTT connection 1950 terminating at the UE 1906 and host 1902. In providing the service to the 'ser, the UE's client application may receive request data f′om the host's host application and provide user data in response to the request data. The OTT connection 1950 may transfer both the request data and the user 'ata. The UE's client application may interact with the user to generate the user data that it provides to the host application through the OTT connection 1950.

The OTT connection 1950 may extend via a connection 1960 between the host 1902 and the network node 1904 and via a wireless connection 1970 between the network node 1904 and the UE 1906 to provide the connection between the host 1902 and the UE 1906. The connection 1960 and wireless connection 1970, over which the OTT connection 1950 may be provided, have been drawn abstractly to illustrate the communication between the host 1902 and the UE 1906 via the network node 1904, without explicit reference to any intermediary devices and the precise routing of messages via these devices.

As an example of transmitting data via the OTT connection 1950, in step 1908, the host 1902 provides user data, which may be performed by executing a host application. In some embodiments, the user data is associated with a particular human user interacting with the UE 1906. In other embodiments, the user data is associated with a UE 1906 that shares data with the host 1902 without explicit human interaction. In step 1910, the host 1902 initiates a transmission carrying the user data towards the UE 1906. The host 1902 may initiate the transmission responsive to a request transmitted by the UE 1906. The request may be caused by human interaction with the UE 1906 or by operation of the client application executing on the UE 1906. The transmission may pass via the network node 1904, in accordance with the teachings of the embodiments described throughout this disclosure. Accordingly, in step 1912, the network node 1904 transmits to the UE 1906 the user data that was carried in the transmission that the host 1902 initiated, in accordance with the teachings of the embodiments described throughout this disclosure. In step 1914, the UE 1906 receives the user data carried in the transmission, which may be performed by a client application executed on the UE 1906 associated with the host application executed by the host 1902.

In some examples, the UE 1906 executes a client application which provides user data to the host 1902. The user data may be provided in reaction or response to the data received from the host 1902. Accordingly, in step 1916, the UE 1906 may provide user data, which may be performed by executing the client application. In providing the user data, the client application may further consider user input received from the user via an input/output interface of the UE 1906. Regardless of the specific manner in which the user data was provided, the UE 1906 initiates, in step 1918, transmission of the user data towards the host 1902 via the network node 1904. In step 1920, in accordance with the teachings of the embodiments described throughout this disclosure, the network node 1904 receives user data from the UE 1906 and initiates transmission of the received user data towards the host 1902. In step 1922, the host 1902 receives the user data carried in the transmission initiated by the UE 1906.

One or more of the various embodiments improve the performance of OTT services provided to the UE 1906 using the OTT connection 1950, in which the wireless connection 1970 forms the last segment.

In an example scenario, factory status information may be collected and analyzed by the host 1902. As another example, the host 1902 may process audio and video data which may have been retrieved from a UE for use in creating maps. As another example, the host 1902 may collect and analyze real-time data to assist in controlling vehicle congestion (e.g., controlling traffic lights). As another example, the host 1902 may store surveillance video uploaded by a UE. As another example, the host 1902 may store or control access to media content such as video, audio, VR or AR which it can broadcast, multicast or unicast to UEs. As other examples, the host 1902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1950 between the host 1902 and UE 1906, in response to variations in the measurement results. The measurement procedure and/or the network functionality for reconfiguring the OTT connection may be implemented in software and hardware of the host 1902 and/or UE 1906. In some embodiments, sensors (not shown) may be deployed in or in association with other devices through which the OTT connection 1950 passes; the sensors may participate in the measurement procedure by supplying values of the monitored quantities exemplified above, or supplying values of other physical quantities from which software may compute or estimate the monitored quantities. The reconfiguring of the OTT connection 1950 may include message format, retransmission settings, preferred routing etc.; the reconfiguring need not directly alter the operation of the network node 1904. Such procedures and functionalities may be known and practiced in the art. In certain embodiments, measurements may involve proprietary UE signaling that facilitates measurements of throughput, propagation times, latency and the like, by the host 1902. The measurements may be implemented in that software causes messages to be transmitted, in particular empty or ‘dummy’ messages, using the OTT connection 1950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Some specific embodiments herein include those enumerated below:

### Group A Embodiments

A1. A method performed by a communication device, the method comprising:
   storing, in different data structures at the communication device, self-organizing network, SON, reports that are of different types and/or that are associated with different types of communication networks.
A2. The method of embodiment A1, wherein said storing comprises storing, in the different data structures, SON reports that are of different types.
A3. The method of any of embodiments A1-A2, wherein the different data structures are specific for and/or dedicated for SON reports of the different respective types.
A4. The method of any of embodiments A1-A3, wherein said storing comprises storing, in the different data structures, SON reports that are associated with different types of communication networks.
A5. The method of any of embodiments A1-A4, wherein the different data structures are specific for and/or dedicated for SON reports associated with the different respective types of networks.
A6. The method of any of embodiments A1-A5, wherein the different types of communication networks include a public network and a non-public network such that at least one of the different data structures is specific for and/or dedicated for SON reports associated with public networks and at least one of the different data structures is specific for and/or dedicated for SON reports associated with non-public networks.
A7. The method of any of embodiments A1-A6, wherein said storing comprises simultaneously storing SON reports across the different data structures.
A8. The method of any of embodiments A1-A7, wherein said storing comprises storing SON reports of the same type in different data structures associated with different respective types of communication networks.
A9. The method of embodiment A8, wherein the SON reports of the same type are radio link failure, RLF, reports.
A10. The method of embodiment A8, wherein the SON reports of the same type are connection establishment failure reports, secondary cell group failure reports, or successful handover reports.
A11. The method of any of embodiments A1-A10, wherein said storing comprises storing, in each data structure, the latest N SON reports, where N>1.
A12. The method of embodiment A11, wherein each SON report is stored until the SON report is fetched by a communication network or until a storage expiration time expires, whichever occurs first.
A13. The method of any of embodiments A1-A12, wherein the stored SON reports report respective occurrences of an SON event.
A14. The method of any of embodiments A1-A13, wherein the different data structures are different variables or different lists.
A15. The method of any of embodiments A1-A14, wherein each of the multiple data structures is associated with:
   a respective network identifier identifying a communication network associated with the data structure; and/or
   a respective network type identifier identifying a type of a communication network associated with the data structure.
A16. The method of embodiment A15, wherein the network type identifier identifies a communication network as being either a public network or a non-public network.
A17. The method of any of embodiments A1-A16, wherein each of the multiple data structures is common to multiple types of SON reports.
A18. The method of any of embodiments A1-A16, further comprising deleting SON reports stored in different ones of the data structures responsive to different deletion events.
A19. The method of embodiment A18, wherein the data structures are associated with different types of communication networks, and wherein the different deletion events are respectively associated with the different types of communication networks.
A20. The method of any of embodiments A1-A19, wherein storing multiple SON reports comprises:
   while in a first communication network, generating and storing one or more first SON reports in a first data structure of the different data structures;
   performing mobility from the first communication network to a second communication network;
   while in the second communication network, generating and storing one or more second SON reports in a second data structure of the different data structures, without deleting or overwriting the one or more first SON reports stored in the first data structure.
A21. The method of embodiment A20, wherein the first and second communication networks are different types of communication networks.
A22. The method of any of embodiments A20-A21, wherein one of the first and second communication networks is a public network and the other of the first and second communication networks is a non-public network.
A23. The method of any of embodiments A20-A22, wherein performing mobility from the first communication network to the second communication network comprises disconnecting from the first communication network and connecting to the second communication network after disconnecting from the first communication network.
A24. The method of any of embodiments A20-A23, further comprising, after performing mobility to the second communication network, transmitting the one or more first SON reports and/or the one or more second SON reports.
A25. The method of any of embodiments A20-A24, wherein the one or more first SON reports and the one or more second SON reports are each the same type of SON report.
A26. The method of any of embodiments A20-A25, wherein the one or more first SON reports and the one or more second SON reports are each an RLF report.
A27. The method of any of embodiments A1-A26, further comprising deleting SON reports stored in different data structures responsive to different deletion events.
A28. The method of embodiment A27, wherein the different deletion events are respectively associated with the different types of communication networks.
A29. The method of embodiment A28, wherein the different types of communication networks include a public network and a non-public network.
A30. The method of any of embodiments A1-A29, further comprising transmitting a message indicating availability of SON reports that are of different types and/or that are associated with different types of communication networks.
A31. The method of any of embodiments A1-A30, wherein the SON reports are associated with different types of communication networks that include a first type and a second type, and wherein the method further comprises transmitting, to a network node, a message indicating availability of only one or more SON reports associated with the first type or the second type of communication network depending respectively on whether the network node belongs to the first type or the second type of communication network.
A32. The method of any of embodiments A1-A30, wherein the SON reports are associated with different communication networks, and wherein the method further comprises transmitting, to a network node, a message indicating availability of only one or more SON reports associated with a communication network to which the network node belongs.
A33. The method of any of embodiments A1-A32, further comprising transmitting one or more of the SON reports.
A34. The method of any of embodiments A1-A33, further comprising generating the SON reports.
AA1. A method performed by a communication device, the method comprising:
   simultaneously storing multiple self-organizing network, SON, reports at the communication device.
AA2. The method of embodiment AA1, wherein simultaneously storing multiple SON reports at the communication device comprises simultaneously storing, at the communication device, multiple SON reports of the same type.
AA3. The method of embodiment AA2, wherein the multiple SON reports of the same type are multiple radio link failure, RLF, reports.
AA4. The method of embodiment AA2, wherein the multiple SON reports of the same type are multiple connection establishment failure reports, multiple secondary cell group failure reports, or multiple successful handover reports.
AA5. The method of any of embodiments AA1-AA4, wherein simultaneously storing multiple SON reports at the communication device comprises simultaneously storing, at the communication device, the latest N SON reports, where N>1.
AA6. The method of any of embodiments AA1-AA5, wherein simultaneously storing multiple SON reports at the communication device comprises simultaneously storing, at the communication device, the latest N SON reports, where N>1, wherein each SON report is stored until the SON report is fetched by a communication network or until a storage expiration time expires, whichever occurs first.
AA7. The method of any of embodiments AA1-AA6, wherein the simultaneously stored SON reports report respective occurrences of an SON event.
AA8. The method of any of embodiments AA1-AA7, wherein simultaneously storing multiple SON reports at the communication device comprises simultaneously storing the multiple SON reports in a data structure at the communication device.
AA9. The method of embodiment AA8, wherein the data structure is a variable or a list.
AA10. The method of any of embodiments AA8-AA9, wherein the data structure is common to multiple types of communication networks such that the multiple SON reports simultaneously stored in the data structure include at least some SON reports for different types of communication networks.
AA11. The method of embodiment AA10, wherein the different types of communication networks include a public network and a non-public network.
AA12. The method of any of embodiments AA8-AA11, wherein the data structure is common to multiple communication networks such that the multiple SON reports simultaneously stored in the data structure include at least some SON reports for different communication networks.
AA13. The method of embodiment AA12, wherein each of the multiple SON reports stored in the data structure is stored with:
   a respective network identifier identifying a communication network associated with the SON report; and/or
   a respective network type identifier identifying a type of a communication network associated with the SON report.
AA14. The method of embodiment AA13, wherein the network type identifier identifies a communication network as being either a public network or a non-public network.
AA15. The method of any of embodiments AA8-AA14, wherein the data structure is specific to a specific type of SON report such that the multiple SON reports simultaneously stored in the data structure include multiple SON reports of the specific type.
AA16. The method of any of embodiments AA1-AA7, wherein simultaneously storing multiple SON reports at the communication device comprises simultaneously storing the multiple SON reports across multiple data structures at the communication device.
AA17. The method of embodiment AA16, wherein the multiple data structures are multiple variables or multiple lists.
AA18. The method of any of embodiments AA16-AA17, wherein the multiple data structures are specific to different respective types of communication networks.
AA19. The method of embodiment AA18, wherein the different respective types of communication networks include a public network and a non-public network.
AA20. The method of any of embodiments AA16-AA19, wherein the multiple data structures are specific to different respective communication networks.
AA21. The method of embodiment AA20, wherein each of the multiple data structures is associated with:
   a respective network identifier identifying a communication network associated with the data structure; and/or
   a respective network type identifier identifying a type of a communication network associated with the data structure.
AA22. The method of embodiment AA21, wherein the network type identifier identifies a communication network as being either a public network or a non-public network.
AA23. The method of any of embodiments AA16-AA22, wherein each of the multiple data structures is common to multiple types of SON reports.
AA24. The method of any of embodiments AA16-AA23, wherein simultaneously storing the multiple SON reports across the multiple data structures at the communication device comprises simultaneously storing multiple SON reports in at least one of the multiple data structures.
AA25. The method of any of embodiments AA16-AA24, further comprising deleting SON reports stored in different ones of the data structures responsive to different deletion events.
AA26. The method of embodiment AA25, wherein the data structures are associated with different types of communication networks, and wherein the different deletion events are respectively associated with the different types of communication networks.
AA27. The method of embodiment AA26, wherein the different types of communication networks include a public network and a non-public network.
AA28. The method of any of embodiments AA1-AA27, wherein simultaneously storing multiple SON reports comprises:
   while in a first communication network, generating and storing one or more first SON reports at the communication device;
   performing mobility from the first communication network to a second communication network;
   while in the second communication network, generating and storing one or more second SON reports at the communication device, without deleting or overwriting the one or more first SON reports stored at the communication device such that the one or more second SON reports are simultaneously stored at the communication device with the one or more first SON reports.
AA29. The method of embodiment AA28, wherein the first and second communication networks are different types of communication networks.
AA30. The method of any of embodiments AA28-AA29, wherein one of the first and second communication networks is a public network and the other of the first and second communication networks is a non-public network.
AA31. The method of any of embodiments AA28-AA29, wherein performing mobility from the first communication network to the second communication network comprises disconnecting from the first communication network and connecting to the second communication network after disconnecting from the first communication network.
AA32. The method of any of embodiments AA28-AA29, further comprising, after performing mobility to the second communication network, transmitting the one or more first SON reports and/or the one or more second SON reports.
AA33. The method of any of embodiments AA28-AA32, wherein the one or more first SON reports and the one or more second SON reports are each the same type of SON report.
AA34. The method of any of embodiments AA28-AA33, wherein the one or more first SON reports and the one or more second SON reports are each an RLF report.
AA35. The method of any of embodiments AA1-AA34, further comprising deleting SON reports associated with different types of communication networks responsive to different deletion events, wherein the different deletion events are respectively associated with the different types of communication networks.
AA36. The method of embodiment AA35, wherein the different types of communication networks include a public network and a non-public network.
AA37. The method of any of embodiments AA1-AA36, further comprising transmitting a message indicating availability of SON reports that are of different types and/or that are associated with different types of communication networks.
AA38. The method of any of embodiments AA1-AA37, wherein the SON reports are associated with different types of communication networks that include a first type and a second type, and wherein the method further comprises transmitting, to a network node, a message indicating availability of only one or more SON reports associated with the first type or the second type of communication network depending respectively on whether the network node belongs to the first type or the second type of communication network.
AA39. The method of any of embodiments AA1-AA37, wherein the SON reports are associated with different communication networks, and wherein the method further comprises transmitting, to a network node, a message indicating availability of only one or more SON reports associated with a communication network to which the network node belongs.
AA40. The method of any of embodiments AA1-AA39, further comprising transmitting one or more of the SON reports.
AA41. The method of any of embodiments AA1-AA40, further comprising generating the SON reports.
AAA1. A method performed by a communication device, the method comprising:
   while in a first communication network, generating and storing one or more first self-optimizing network, SON, reports at the communication device;
   performing mobility from the first communication network to a second communication network; and
   while in the second communication network, generating and storing one or more second SON reports at the communication device, without deleting or overwriting the one or more first SON reports stored at the communication device.
AAA2. The method of embodiment AAA2, wherein the one or more second SON reports are simultaneously stored at the communication device with the one or more first SON reports.
AAA3. The method of any of embodiments AAA1-AAA2, wherein the first and second communication networks are different types of communication networks.
AAA4. The method of any of embodiments AAA1-AAA3, wherein one of the first and second communication networks is a public network and the other of the first and second communication networks is a non-public network.
AAA5. The method of any of embodiments AAA1-AAA4, wherein performing mobility from the first communication network to the second communication network comprises disconnecting from the first communication network and connecting to the second communication network after disconnecting from the first communication network.
AAA6. The method of any of embodiments AAA1-AAA5, further comprising, after performing mobility to the second communication network, transmitting the one or more first SON reports and/or the one or more second SON reports.
AAA7. The method of any of embodiments AAA1-AAA6, wherein the one or more first SON reports and the one or more second SON reports are each the same type of SON report.
AAA8. The method of any of embodiments AAA1-AAA7, wherein the one or more first SON reports and the one or more second SON reports are each an RLF report.
AAAA1. A method performed by a communication device, the method comprising:
   transmitting, to a network node, a message containing a non-public network, NPN, self-optimizing network, SON, report that is specific to NPNs.
AAAA2. The method of embodiment AAAA1, wherein the NPN SON report is an NPN radio link failure, RLF, report.
AAAA3. The method of embodiment AAAA2, wherein the NPN RLF report includes radio link failure information or handover failure information in an NPN.
AAAA4. The method of embodiment AAAA1, wherein the NPN SON report is an NPN random access channel, RACH, report.
AAAA5. The method of any of embodiments AAAA1-AAAA4, wherein the NPN SON report includes an identifier of an NPN to which the NPN SON report relates.
AA. The method of any of the previous embodiments, further comprising:
   providing user data; and
   forwarding the user data to a host computer via the transmission to a base station.

### Group B Embodiments

B1. A method performed by a network node, the method comprising:
   receiving, from a communication device, a message indicating availability of SON reports that are of different types and/or that are associated with different types of communication networks.
B2. The method of embodiment B1, wherein the message indicates availability of SON reports that are associated with different types of communication networks, wherein the different types of communication networks include a public network and a non-public network.
B3. A method performed by a network node, the method comprising:
   receiving, from a communication device, a message containing a non-public network, NPN, self-optimizing network, SON, report that is specific to NPNs.
B4. The method of embodiment B3, wherein the NPN SON report is an NPN radio link failure, RLF, report.
B5. The method of embodiment B4, wherein the NPN RLF report includes radio link failure information or handover failure information in an NPN.
B6. The method of embodiment B4, wherein the NPN SON report is an NPN random access channel, RACH, report.
B7. The method of any of embodiments B3-B6, wherein the NPN SON report includes an identifier of an NPN to which the NPN SON report relates.
B8. The method of embodiment B7, wherein the network node belongs to a different communication network than a communication network to which the NPN SON report relates and wherein the method further comprises forwarding the NPN SON report to the communication network to which the NPN SON report relates.
B9. The method of any of embodiments B1-B7, further comprising, based on the NPN SON report, adapting a configuration of a communication network to which the NPN SON report relates.
BB. The method of any of the previous embodiments, further comprising:
   obtaining user data; and
   forwarding the user data to a host computer or a communication device.

### Group C Embodiments

C1. A communication device configured to perform any of the steps of any of the Group A embodiments.
C2. A communication device comprising processing circuitry configured to perform any of the steps of any of the Group A embodiments.
C3. A communication device comprising:
   communication circuitry; and
   processing circuitry configured to perform any of the steps of any of the Group A embodiments.
C4. A communication device comprising:
   processing circuitry configured to perform any of the steps of any of the Group A embodiments; and
   power supply circuitry configured to supply power to the communication device.
C5. A communication device comprising:
   processing circuitry and memory, the memory containing instructions executable by the processing circuitry whereby the communication device is configured to perform any of the steps of any of the Group A embodiments.
C6. The communication device of any of embodiments C1-C5, wherein the communication device is a wireless communication device.
C7. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
C8. A computer program comprising instructions which, when executed by at least one processor of a communication device, causes the communication device to carry out the steps of any of the Group A embodiments.
C9. A carrier containing the computer program of embodiment C7, wherein the carrier is one of an electronic signal, optical signal, radio signal, or computer readable storage medium.
C10. A network node configured to perform any of the steps of any of the Group B embodiments.
C11. A network node comprising processing circuitry configured to perform any of the steps of any of the Group B embodiments.
C12. A network node comprising:
   communication circuitry; and
   processing circuitry configured to perform any of the steps of any of the Group B embodiments.
C13. A network node comprising:
   processing circuitry configured to perform any of the steps of any of the Group B embodiments;
   power supply circuitry configured to supply power to the network node.
C14. A network node comprising:
   processing circuitry and memory, the memory containing instructions executable by the processing circuitry whereby the network node is configured to perform any of the steps of any of the Group B embodiments.
C15. The network node of any of embodiments C10-C14, wherein the network node is a base station.
C16. A computer program comprising instructions which, when executed by at least one processor of a network node, causes the network node to carry out the steps of any of the Group B embodiments.
C17. The computer program of embodiment C16, wherein the network node is a base station.
C18. A carrier containing the computer program of any of embodiments C16-C17, wherein the carrier is one of an electronic signal, optical signal, radio signal, or computer readable storage medium.

### Group D Embodiments

D1. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
D2. The communication system of the previous embodiment further including the base station.
D3. The communication system of the previous 2 embodiments, further including the UE, wherein the UE is configured to communicate with the base station.
D4. The communication system of the previous 3 embodiments, wherein:
   the processing circuitry of the host computer is configured to execute a host application, thereby providing the user data; and
   the UE comprises processing circuitry configured to execute a client application associated with the host application.
D5. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
D6. The method of the previous embodiment, further comprising, at the base station, transmitting the user data.
D7. The method of the previous 2 embodiments, wherein the user data is provided at the host computer by executing a host application, the method further comprising, at the UE, executing a client application associated with the host application.
D8. A user equipment (UE) configured to communicate with a base station, the UE comprising a radio interface and processing circuitry configured to perform any of the previous 3 embodiments.
D9. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
D10. The communication system of the previous embodiment, wherein the cellular network further includes a base station configured to communicate with the UE.
D11. The communication system of the previous 2 embodiments, wherein:
   the processing circuitry of the host computer is configured to execute a host application, thereby providing the user data; and
   the UE's processing circuitry is configured to execute a client application associated with the host application.
D12. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
D13. The method of the previous embodiment, further comprising at the UE, receiving the user data from the base station.
D14. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
D15. The communication system of the previous embodiment, further including the UE.
D16. The communication system of the previous 2 embodiments, further including the base station, wherein the base station comprises a radio interface configured to communicate with the UE and a communication interface configured to forward to the host computer the user data carried by a transmission from the UE to the base station.
D17. The communication system of the previous 3 embodiments, wherein:
   the processing circuitry of the host computer is configured to execute a host application; and
   the UE's processing circuitry is configured to execute a client application associated with the host application, thereby providing the user data.
D18. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
D19. A method implemented in a communication system including a host computer, a base station and a user equipment (UE), the method comprising:
   at the host computer, receiving user data transmitted to the base station from the UE, wherein the UE performs any of the steps of any of the Group A embodiments.
D20. The method of the previous embodiment, further comprising, at the UE, providing the user data to the base station.
D21. The method of the previous 2 embodiments, further comprising:
   at the UE, executing a client application, thereby providing the user data to be transmitted; and
   at the host computer, executing a host application associated with the client application.
D22. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
D24. The communication system of the previous embodiment further including the base station.
D25. The communication system of the previous 2 embodiments, further including the UE, wherein the UE is configured to communicate with the base station.
D26. The communication system of the previous 3 embodiments, wherein:
   the processing circuitry of the host computer is configured to execute a host application;
   the UE is configured to execute a client application associated with the host application, thereby providing the user data to be received by the host computer.
D27. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
D28. The method of the previous embodiment, further comprising at the base station, receiving the user data from the UE.
D29. The method of the previous 2 embodiments, further comprising at the base station, initiating a transmission of the received user data to the host computer.

1.-35. (canceled)

36. A method performed by a communication device, the method comprising:
storing, at the communication device, a self-organizing network (SON) report associated with a non-public network (NPN), including storing the SON report in association with an NPN identifier of the NPN with which the SON report is associated; and
if a serving network of the communication device is an NPN identified by an NPN identifier which matches the NPN identifier associated with the SON report, transmitting a message to the serving network indicating that the SON report is available at the communication device.

37. The method of claim 36, further comprising checking if the serving network of the communication device is an NPN identified by an NPN identifier which matches the NPN identifier associated with the SON report, and wherein transmitting the message comprises transmitting the message if, according to said checking, the serving network of the communication device is an NPN identified by an NPN identifier which matches the NPN identifier associated with the SON report.

38. The method of claim 36, wherein the NPN is a standalone NPN, and wherein the NPN identifier is a combination of a Public Land Mobile Network identifier and a Network ID.

39. The method of claim 36, wherein the SON report includes radio link failure information or handover failure information in the NPN.

40. The method of claim 36, further comprising:
after transmitting the message, receiving a request from the serving network node for the SON report; and
responsive to the request, transmitting the SON report to the serving network.

41. A method performed by a communication device, the method comprising:
simultaneously storing multiple self-organizing network (SON) reports at the communication device, including an SON report associated with a non-public network, by:
storing the multiple SON reports in a data structure that is common to multiple communication networks or multiple types of communication networks, with each SON report being stored with a respective network identifier identifying a communication network associated with the SON report and/or a respective network type identifier identifying a type of a communication network associated with the SON report; or
storing the multiple SON reports across different data structures that are specific to different respective communication networks and/or specific to different respective types of communication networks.

42. The method of claim 41, wherein simultaneously storing multiple SON reports comprises:
while in a first communication network, generating and storing one or more first SON reports at the communication device;
performing mobility from the first communication network to a second communication network; and
while in the second communication network, generating and storing one or more second SON reports at the communication device, without deleting or overwriting the one or more first SON reports stored at the communication device such that the one or more second SON reports are simultaneously stored at the communication device with the one or more first SON reports.

43. The method of claim 41, wherein simultaneously storing multiple SON reports at the communication device comprises simultaneously storing multiple SON reports of the same type, wherein each of the SON reports includes radio link failure information or handover failure information.

44. A method performed by a network node, the method comprising:
receiving, from a communication device, a message containing a non-public network (NPN) self-optimizing network (SON) report that is specific to NPNs; and
based on the NPN SON report, adapting a configuration of a communication network to which the NPN SON report relates.

45. The method of claim 44, wherein the NPN SON report includes an identifier of an NPN to which the NPN SON report relates.

46. The method of claim 44, wherein the NPN SON report is an NPN radio link failure (RLF) report or an NPN random access channel (RACH) report.

47. A communication device comprising:
communication circuitry; and
processing circuitry configured to:
store, at the communication device, a self-organizing network (SON) report associated with a non-public network (NPN) including storing the SON report in association with an NPN identifier of the NPN with which the SON report is associated; and
if a serving network of the communication device is an NPN identified by an NPN identifier which matches the NPN identifier associated with the SON report, transmit a message to the serving network indicating that the SON report is available at the communication device.

48. The communication device of claim 47, the processing circuitry further configured to check if the serving network of the communication device is an NPN identified by an NPN identifier which matches the NPN identifier associated with the SON report, and to transmit the message if, according to the check, the serving network of the communication device is an NPN identified by an NPN identifier which matches the NPN identifier associated with the SON report.

49. The communication device of claim 47, wherein the NPN is a standalone NPN, and wherein the NPN identifier is a combination of a Public Land Mobile Network identifier and a Network ID.

50. The communication device of claim 47, wherein the SON report includes radio link failure information or handover failure information in the NPN.

51. The communication device of claim 47, the processing circuitry further configured to:
after transmitting the message, receiving a request from the serving network node for the SON report; and
responsive to the request, transmitting the SON report to the serving network.

52. A communication device comprising:
communication circuitry; and
processing circuitry configured to simultaneously store multiple self-organizing network (SON) reports at the communication device, including an SON report associated with a non-public network, by:
storing the multiple SON reports in a data structure that is common to multiple communication networks or multiple types of communication networks, with each SON report being stored with a respective network identifier identifying a communication network associated with the SON report and/or a respective network type identifier identifying a type of a communication network associated with the SON report; or
storing the multiple SON reports across different data structures that are specific to different respective communication networks and/or specific to different respective types of communication networks.

53. The communication device of claim 49, wherein the processing circuitry is configured to simultaneously store the multiple SON reports by:
while in a first communication network, generating and storing one or more first SON reports at the communication device;
performing mobility from the first communication network to a second communication network; and
while in the second communication network, generating and storing one or more second SON reports at the communication device, without deleting or overwriting the one or more first SON reports stored at the communication device such that the one or more second SON reports are simultaneously stored at the communication device with the one or more first SON reports.

54. The communication device of claim 49, wherein the processing circuitry is configured to simultaneously store the multiple SON reports by simultaneously storing multiple SON reports of the same type, wherein each of the SON reports includes radio link failure information or handover failure information.

55. A network node comprising:
communication circuitry; and
processing circuitry configured to:
receive, from a communication device, a message containing a non-public network (NPN) self-optimizing network (SON) report that is specific to NPNs; and
based on the NPN SON report, adapt a configuration of a communication network to which the NPN SON report relates.

56. The network node of claim 55, wherein the NPN SON report includes an identifier of an NPN to which the NPN SON report relates.

57. The network node of claim 55, wherein the NPN SON report is an NPN radio link failure (RLF) report or an NPN random access channel (RACH) report.
